(19) United States
(12) Patent Application Publication
(10) Pub. No.: US 2025/0335021 A1
(43) Pub. Date: Oct. 30, 2025

(54) MULTIMODAL OUTPUT OPTIMIZATION IN EXTENDED REALITY SYSTEMS AND METHODS OF USE THEREOF

(71) Applicant: Meta Platforms Technologies, LLC, Menlo Park, CA (US)

(72) Inventors: Mark Parent, Toronto (CA); Benjamin Lafreniere, Toronto (CA); Tanya Renee Jonker, Seattle, WA (US); Martha Irene Smith, Redmond, WA (US); Wangxing Fu, North York (CA); Jared Braun, Austin, TX (US); Michelle Li, Toronto (CA); Dylan Wallace, Toronto (CA); Brian Simpson, Woodinville, WA (US); Michael Croswell, Fort Collins, CO (US); Weilun Gong, London (GB); Monica Sewell, Ellensburg, WA (US); Denis Kozhokar, Circle Pines, MN (US)

(21) Appl. No.: 19/093,107

(22) Filed: Mar. 27, 2025

Related U.S. Application Data
(60) Provisional application No. 63/638,328, filed on Apr. 24, 2024.

(51) Int. Cl. G06F 3/01; G08B 21/18

(52) U.S. Cl. CPC G06F 3/011; G06F 3/016; G08B 21/18

(57) ABSTRACT

A system for controlling notification outputs at a head-wearable device that is in communication with one or more peripherals. The system is configured to receive a request to provide a notification, and in response to receiving the request to provide the notification: in accordance with a determination that the head wearable device and one of the one or more peripheral devices are in a first state based on first data from one or more sensors of the system, presenting a notification in a first manner that corresponds to the request to provide the notification, and in accordance with a determination that the head wearable device and one of the one or more peripheral devices are in a second state based on second data from the one or more sensors of the system, presenting a notification in a second manner that corresponds to the request to provide the notification.

### RELATED APPLICATION

This application claims priority to U.S. Provisional Application Ser. No. 63/638,328 filed Apr. 24, 2024, which is hereby incorporated by reference in its entirety.

### TECHNICAL FIELD

This relates generally to a system for determining how to provide notifications in a system that includes multiple modalities for presenting notifications, where these modalities include both the device (e.g., a head-wearable device system than includes one or more peripheral devices that are in communication with the head-wearable device) in which the notification is presented at and what notification modality is used at said device (e.g., a visual notification, a haptic notification, and/or an audio notification).

### BACKGROUND

Providing notifications at an electronic device in different manner based on a few use cases such as a user of the device, e.g., operating a vehicle, or the user specifying that they do not want to be disturbed. While providing notifications like this can control unwanted notifications in some manner, these techniques do not work well in multi-device systems and can become distracting or on the contrary ineffective in providing notifications to the user.

As such, there is a need to address one or more of the above-identified challenges. A brief summary of solutions to the issues noted above are described below.

### SUMMARY

The systems and methods described herein provide a notification architecture designed to be used across multiple devices being worn by a user, e.g., a user wearing a head-wearable device and one or more peripheral devices. For example, in one embodiment a user can be wearing a head-wearable device (e.g., an extended-reality headset) and a wrist-wearable device, and the system can determine which device(s) to present the notification at and in what manner (e.g., audible, haptic, and/or visual). The notifications can be provided based on one or more sensors of the devices, such that the notifications can be provided effectively based on inferred and/or determined contextual information (e.g., user is in conversation, user is distracted, user is focused on something, etc.).

One example system for controlling notification outputs is described herein. The system comprises a head-wearable device (e.g., an extended-reality headset such as an augmented reality headset) that is in communication with one or more peripherals (e.g., a wrist-wearable device, an intermediary processing device, a cellphone, a laptop, a monitor, a television, etc.). The system is configured to receive a request to provide a notification (e.g., a notification from an application, such as a reminder application, an order notification, a message notification, etc.). The system is further configured to, in response to receiving the request to provide the notification (notification and alert are used interchangeably throughout): in accordance with a determination (e.g., automatically and without human intervention) that the head wearable device and one of the one or more peripheral devices are in a first state based on first data from one or more sensors (and/or electrical components (e.g., a Bluetooth connection, a Wi-Fi connection, a cellular connection, etc.)) of the system, presenting a notification in a first manner that corresponds to the request to provide the notification; and in accordance with a determination (e.g., automatically and without human intervention) that the head wearable device and one of the one or more peripheral devices are in a second state based on second data from the one or more sensors (and/or electrical components (e.g., a Bluetooth connection, a Wi-Fi connection, a cellular connection, etc.)) of the system, presenting a notification in a second manner that corresponds to the request to provide the notification.

Being able to dynamically adjust how and when notifications and other information (e.g., media) are provided to the user based on external factors such as environment, activity, location, etc., help reduce unwanted interactions with the system configured to provide notifications to the user. By reducing unwanted interactions the user no longer needs to manually adjust how notifications are presented to them (e.g., by going to into settings user interfaces). In addition, by dynamically adjusting how notifications are received, the user is more likely to be notified of a notification, as opposed to missing it. Furthermore, in a system that includes multiple electronic devices that are all configured to provide notifications, having too many notifications can become an issue along with confusing the user as to what each notification means. Thus, it is beneficial to have a system that controls these notifications in concert with one another and provides notifications in the most efficient manner possible. In summary, this system reduces setting interactions required by the user, improves battery life by not having excess notifications, and provides a better user experience.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1I illustrate a user wearing an extended reality system that includes a head-wearable device and other peripheral devices, and receiving notifications across those devices based on external factors, in accordance with some embodiments.

FIG. 2 illustrates a user interacting with either an extended-reality and receiving an urgent notification that supersedes other considerations as to whether to delay or deemphasize notifications, in accordance with some embodiments.

FIG. 3 shows an example method flow chart for presenting a notification in an extended-reality system, in accordance with some embodiments.

FIGS. 4A, 4B, 4C-1, 4C-2, 4D-1, and 4D-2 illustrate example artificial-reality systems, in accordance with some embodiments.

FIGS. 5A-5B illustrate an example wrist-wearable device 500, in accordance with some embodiments.

FIGS. 6A, 6B-1, 6B-2, and 6C illustrate example head-wearable devices, in accordance with some embodiments.

FIGS. 7A-7B illustrate an example handheld intermediary processing device, in accordance with some embodiments.

FIGS. 8A-8C illustrate an example smart textile-based garment, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

Embodiments of this disclosure can include or be implemented in conjunction with various types or embodiments of artificial-reality systems. Artificial-reality (AR), as described herein, is any superimposed functionality and or sensory-detectable presentation provided by an artificial-reality system within a user's physical surroundings. Such artificial-realities can include and/or represent virtual reality (VR), augmented reality, mixed artificial-reality (MAR), or some combination and/or variation one of these. For example, a user can perform a swiping in-air hand gesture to cause a song to be skipped by a song-providing API providing playback at, for example, a home speaker. An AR environment, as described herein, includes, but is not limited to, VR environments (including non-immersive, semi-immersive, and fully immersive VR environments); augmented-reality environments (including marker-based augmented-reality environments, markerless augmented-reality environments, location-based augmented-reality environments, and projection-based augmented-reality environments); hybrid reality; and other types of mixed-reality environments.

Artificial-reality content can include completely generated content or generated content combined with captured (e.g., real-world) content. The artificial-reality content can include video, audio, haptic events, or some combination thereof, any of which can be presented in a single channel or in multiple channels (such as stereo video that produces a three-dimensional effect to a viewer). Additionally, in some embodiments, artificial reality can also be associated with applications, products, accessories, services, or some combination thereof, which are used, for example, to create content in an artificial reality and/or are otherwise used in (e.g., to perform activities in) an artificial reality.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMU)s of a wrist-wearable device) and/or detected via image data captured by an imaging device of a wearable device (e.g., a camera of a head-wearable device)) or a combination of the user's hands. In-air means, in some embodiments, that the user hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single or double finger tap on a table, on a user's hand or another finger, on the user's leg, a couch, a steering wheel, etc.). The different hand gestures disclosed herein can be detected using image data and/or sensor data (e.g., neuromuscular signals sensed by one or more biopotential sensors (e.g., EMG sensors) or other types of data from other sensors, such as proximity sensors, time-of-flight (ToF) sensors, sensors of an inertial measurement unit, etc.) detected by a wearable device worn by the user and/or other electronic devices in the user's possession (e.g., smartphones, laptops, imaging devices, intermediary devices, and/or other devices described herein).

Described herein are numerous techniques for providing notifications to a user wearing multiple electronic devices, primarily including a head wearable device and one or more peripheral devices. The below descriptions and scenarios are for explanatory purposes, but the techniques can be used in many different real-life scenarios, such as working, driving, walking, studying, working, resting, focusing, attending an event, etc.

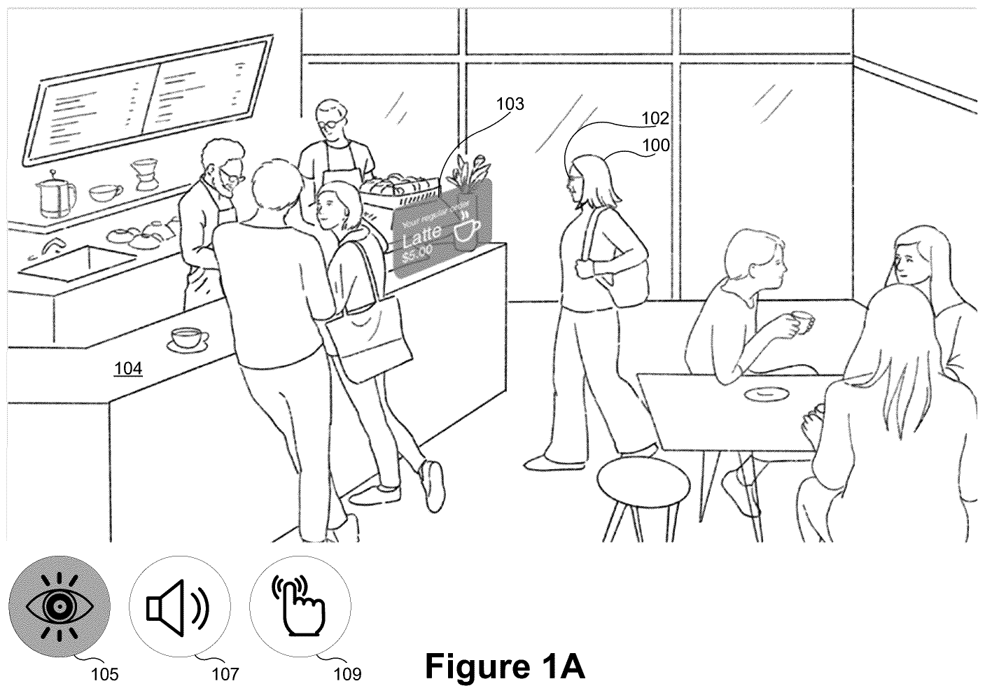

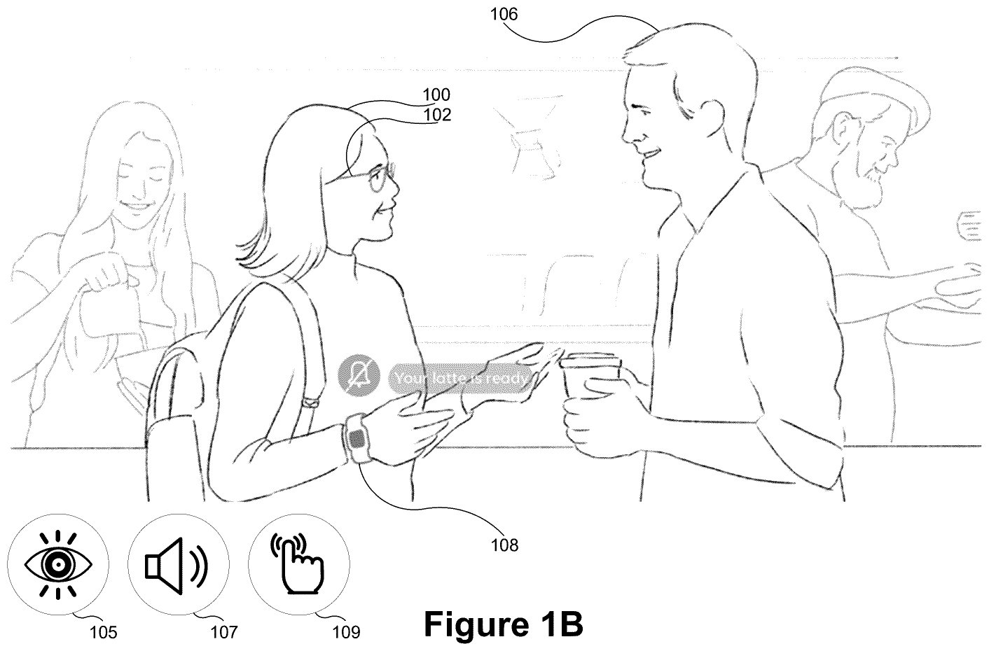

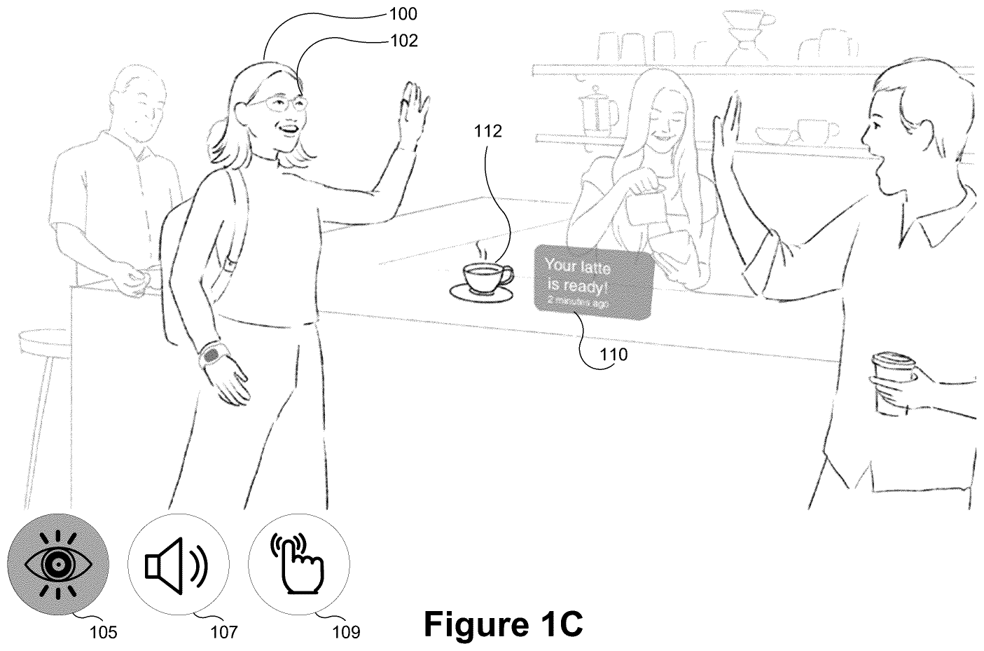

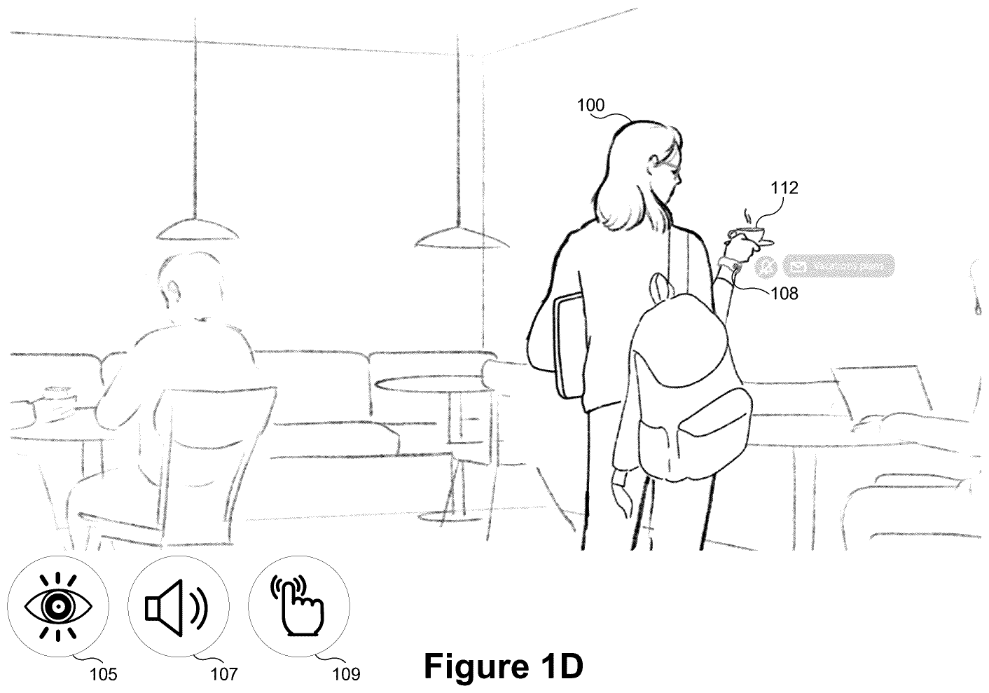

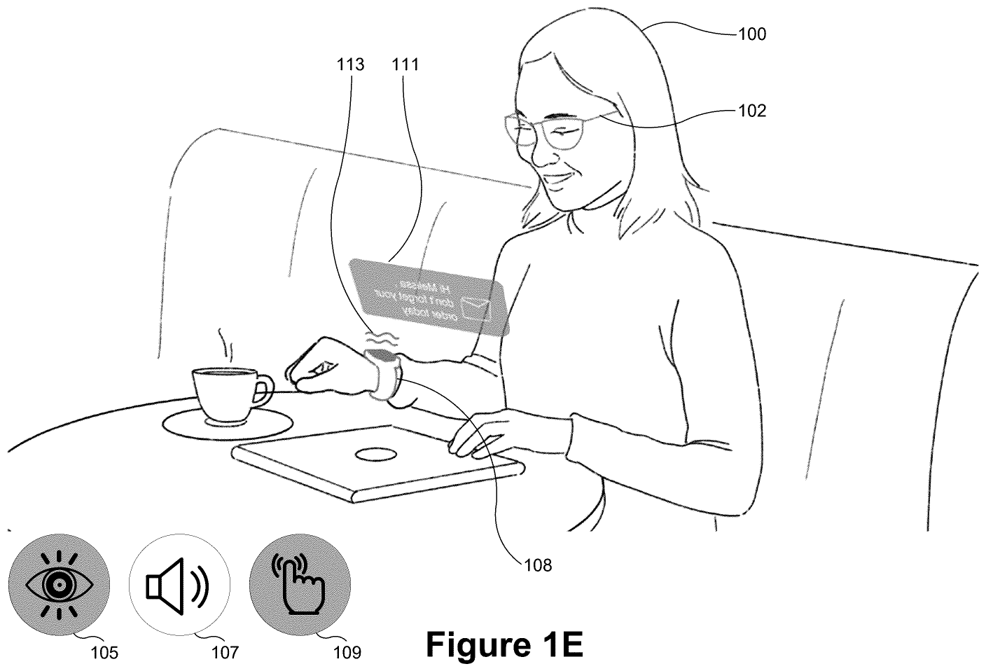

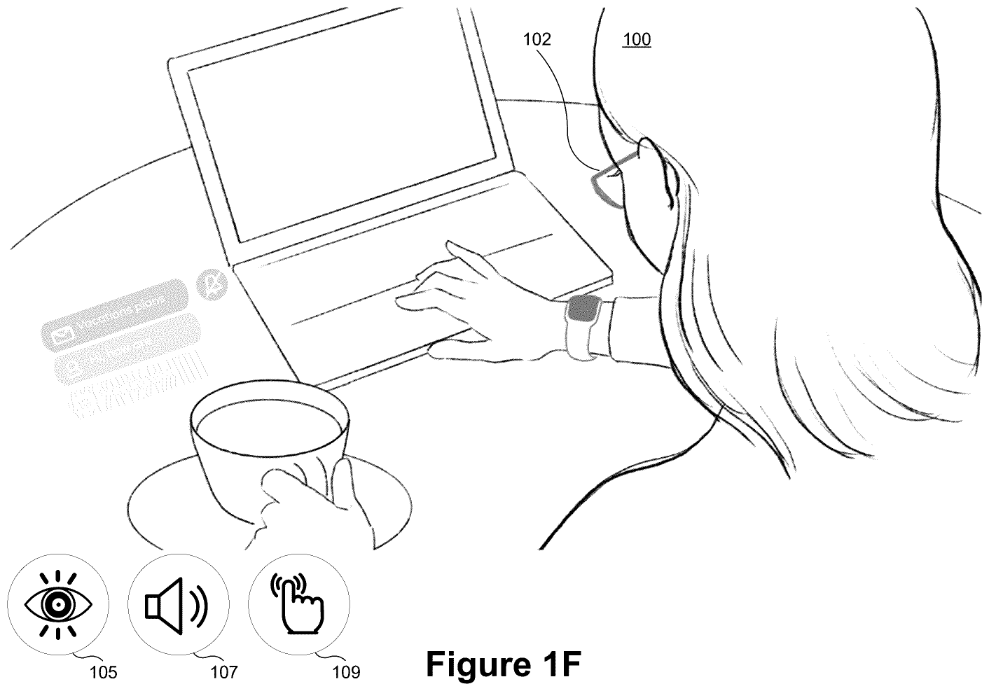

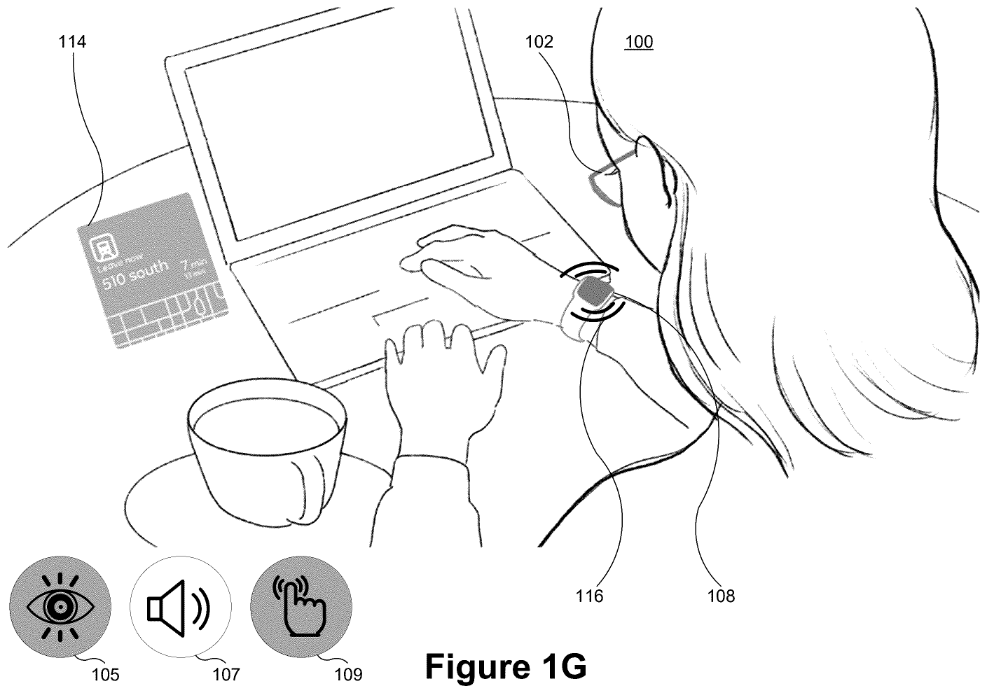

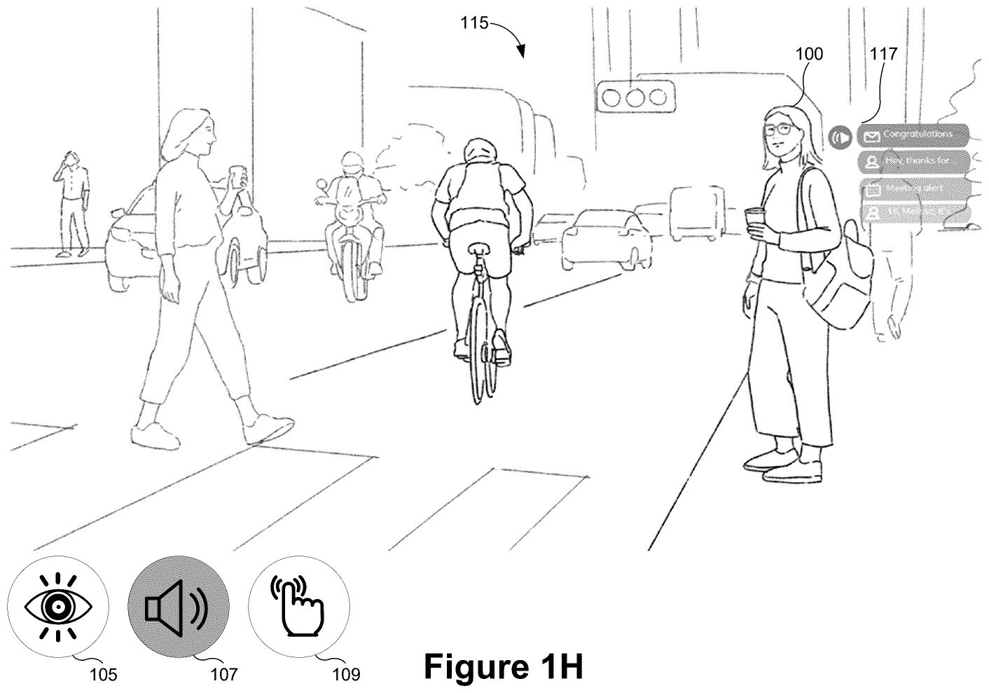

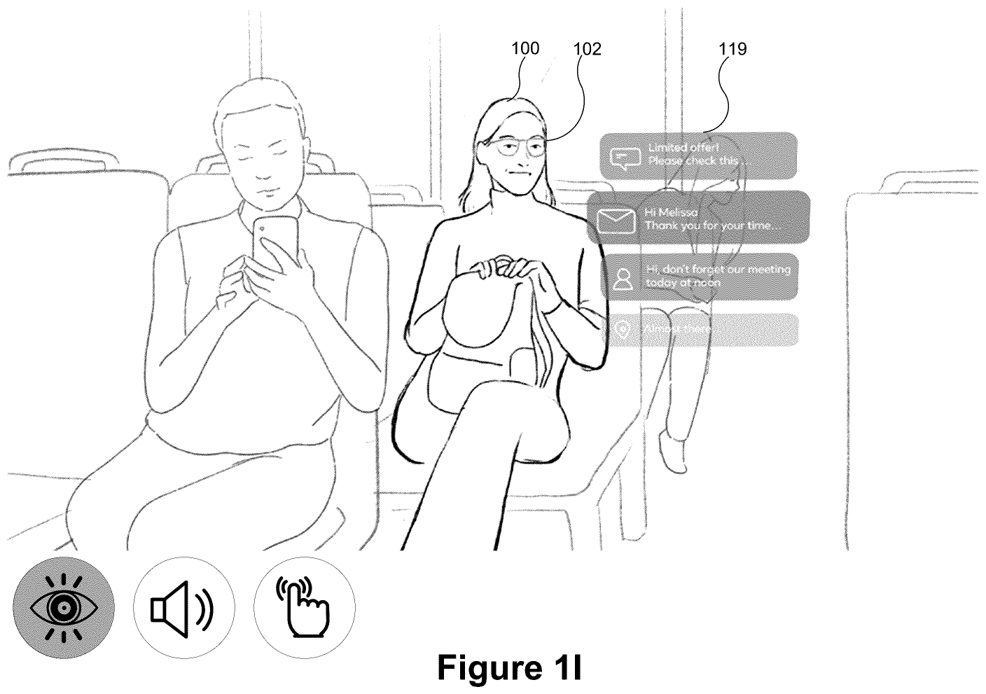

FIGS. 1A-1I illustrate a user wearing an extended reality system that includes a head-wearable device and other peripheral devices, and receiving notifications across those devices based on external factors, in accordance with some embodiments. FIG. 1A illustrates a user 100 that is wearing at least a head-wearable device such as an augmented-reality headset 102. In this interaction, the extended-reality system uses contextual information such as environment detected by at least a camera of the augmented-reality headset 102 and a GPS sensor to determine that the user 100 is at a café and approaching a counter 104. In response, the augmented-reality headset 102 is configured to automatically present the user with a notification corresponding to this information. As shown in this example, the augmented-reality headset provides notification in the form an extended reality (XR) augment (e.g., a user interface element) 103 that displays the user's typical drink that they order from the café. The user can interact with XR augment 103 to place their order, e.g., by interacting through the user of an input device such an hand gesture detected by a wrist-wearable device. FIG. 1A also shows that the notification is provided visually by the eye glyph 105 being emphasized. In addition, FIG. 1A also illustrates that neither an audio notification nor a haptic notification are being transmitted, as indicated by audio glyph 107 being deselected and haptic glyph 109 being deselected, respectively.

FIG. 1B illustrates a later point in time from what was shown in FIG. 1A where the user 100 is now interacting/conversing with another person 106 and delaying providing the notification to the user 100 that their order is ready. In some embodiments, the system determines that the user 100 is interacting with another person 106 based on camera data (e.g., camera's configured to use AI/ML to detect certain objects, such as people) and microphone data (e.g., using a microphone and processing audio to determine if the user 100 is engaging in a conversation). As shown in FIG. 1B the user 100, in some embodiments, can also be wearing a wrist-wearable device 108 that is configured to also provide notifications as part of the extended-reality system. In some embodiments, the notification can be delivered silently to the user at the wrist-wearable device 108 such that they can manually check it if needed. FIG. 1B also shows that none of the notifications are being provided, as the eye glyph 105, the audio glyph 107, and the haptic glyph 109 all indicate they are not being used. In another example, while not pictured here, a user 100 may still receive an audio notification that interrupts an ongoing conversation in the event that the system is determines that the notification has a higher priority than the ongoing conversation. For example, notifications that involve a time aspect can be prioritized over a conversation, e.g., user 100 may miss their train if they do not start heading to the train.

FIG. 1C illustrates that after the conversation that was illustrated in FIG. 1B has ended, the augmented reality headset 102 now displays an XR augment of the notification 110 that was previously delayed indicating that the user's 100 coffee 112 is ready. In some embodiments, the XR augment can also include a time stamp to indicate when the notification was first received. FIG. 1C also shows that the notification is provided visually by the eye glyph 105 being emphasized.

FIG. 1D shows the user 100 walking with their coffee order, and receiving a request to present a notification to the user. However, the extended-reality system determines the user is performing an activity that requires heightened attention by the user, such as carrying a hot cup of coffee 112. In some embodiments, the extended-reality system can determine that the user 100 is performing a potentially dangerous activity, and delaying providing the notification to the user 100. The system may determine the user is holding a cup of coffee 112 via a camera at the augmented-reality headset 102. In some embodiments, the system can determine the user is also walking using IMU data, and can infer that if a cup of coffee is detected and walking is detected to forgo providing a notification until at least one of those two factors is no longer present. FIG. 1D also shows that none of the notifications are being provided, as the eye glyph 105, the audio glyph 107, and the haptic glyph 109 all indicate they are not being used.

FIG. 1E illustrates that the user 100 has now sat down and is no longer in a situation that requires heightened attention. Upon determining that the situation has changed, the notification that was delayed in FIG. 1D is now presented as an AR augment 111 via the augmented reality headset 102, and a haptic feedback 113 is provided via the wrist-wearable device 108. The user 100 now receives the notification in multiple modalities as is indicated by the eye glyph 105 and the haptic glyph 109 indicating they are being used.

FIG. 1F illustrates the user focused on work emails, and again forgoes presenting notifications to the user to avoid distractions. In some embodiments, the user specifies they are focusing on a certain task. In some embodiments, the system cross references a calendar associated with user 100 and determines whether notifications should be delayed. In some embodiments, a camera of the augmented reality glasses 102 is configured to determine if the user 100 is focusing on something that requires attention. FIG. 1F also shows that none of the notifications are being provided, as the eye glyph 105, the audio glyph 107, and the haptic glyph 109 all indicate they are not being used.

FIG. 1G shows that despite the user focusing, the system interrupts the user 100 with notifications (e.g., XR augment 114 provided by the augmented-reality glasses 102 and haptic feedback 116 provided the wrist-wearable device 108 to ensure they do not miss their commute or appointment. This notification may be provided by cross referencing a calendar associated with user 100. The user 100 now receives the notification in multiple modalities as is indicated by the eye glyph 105 and the haptic glyph 109 indicating they are being used.

FIG. 1H illustrates that the user is now waiting for their transportation to arrive, and in response to detecting that the user 100 is waiting, the system provides notifications that were delayed throughout the day that had not yet been conveyed to the user 100. In some embodiments, the system determines the user is waiting based on global positioning (GPS) data, camera data, ambient light sensor data, calendar data, IMU data, etc. Since the user 100 is in a bright outdoor environment 115 the notifications are provided auditorily so that the notifications 117 are not missed due to the bright environment interfering with the display of the notification. Alternatively, and/or in addition to the brightness detected, the system can also choose to provide notifications auditorily based on safety considerations due to possibly obstructing dangerous objects in the surrounding environment (e.g., a car). In some embodiments, the haptic feedback in not provided as the vibrations from the surrounding environment (e.g., car engines, public transport, etc.) make it difficult to feel a haptic feedback. Thus, the user 100 receives the notification in a single modality as is indicated by audio glyph 107 indicating that an audio notification is being provided.

FIG. 1I shows the user 100 now on public transportation, and in response to detecting that the user 100 is on public transportation (e.g., semi-indoors), the system provides notifications 119 via the augmented-reality glasses 102 as opposed to just audio notifications. In some embodiments, the system provides notifications 110 via the augmented reality glasses 102 in response to detecting the user is on public transportation, as the ambient noise while on public transit can make audio notifications difficult to hear and potentially interrupt public transit stop alerts (not provided by the system). Since the wearer of the system is determined to be sitting or stationary relative to the movement of the public transit, then they will have a greater visual capacity and be able to easily read information rich visual notifications. Thus, the user 100 receives the notification in a single modality as is indicated by eye glyph 105 indicating that a visual notification is being provided.

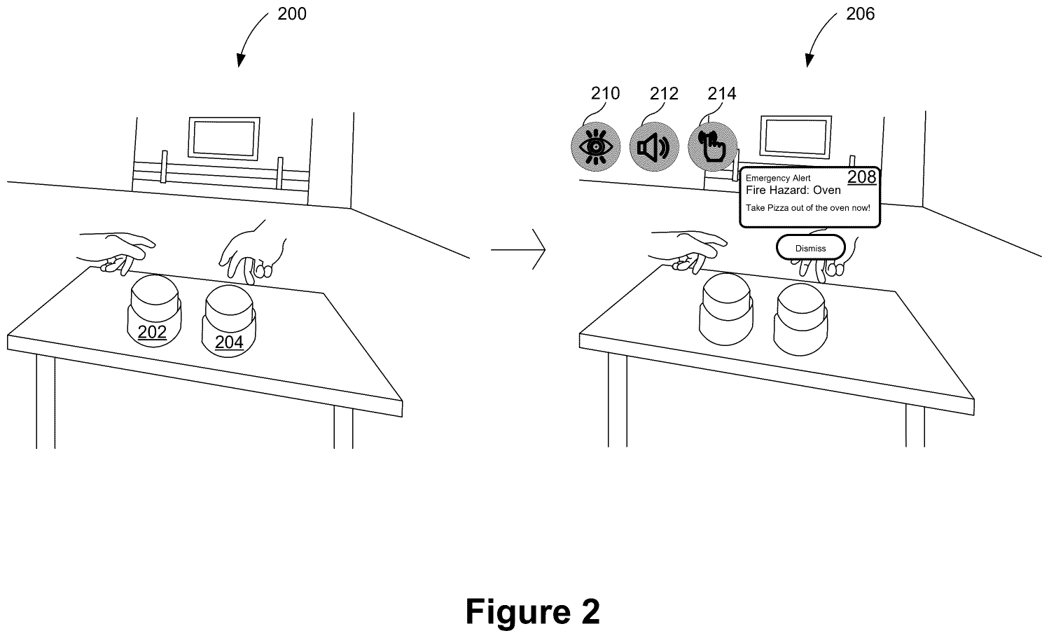

FIG. 2 illustrates a user interacting with an extended-reality environment and receiving an urgent notification that supersedes other considerations as to whether to delay or deemphasize notifications, in accordance with some embodiments. FIG. 2 illustrates in a first pane 200 the user interacting with an extended-reality including interacting with a game illustrated by buttons 202 and 204. A second pane 206 shows an urgent notification being displayed via XR augment 208 indicating that a potentially dangerous situation is occurring or about to occur. As shown in the second pane 206, the eye glyph 210 indicates that a visual notification is being provided (e.g., XR augment 208), the audio glyph 212 indicates that the an audio notification is also being provided (e.g., by playing audio at extended reality headset that reads the text of the visual notification), and the haptic glyph 214 indicates that a haptic is also being provided (e.g., a haptic vibration is provided at a wrist-wearable device). Below are additional details relating to the descriptions provided above.

(A1) In accordance with some embodiments, a system for controlling notification outputs comprises a head-wearable device (e.g., an extended-reality headset such as an augmented reality headset) that is in communication with one or more peripherals (e.g., a wrist-wearable device, an intermediary processing device, a cellphone, a laptop, a monitor, a television, etc.). The system is configured to: receive a request to provide a notification (e.g., a notification from an application, such as a reminder application, an order notification, a message notification, etc.), and in response to receiving the request to provide the notification: in accordance with a determination (e.g., automatically and without human intervention) that the head wearable device and one of the one or more peripheral devices are in a first state based on first data from one or more sensors (and/or electrical components (e.g., a Bluetooth connection, a Wi-Fi connection, a cellular connection, etc.)) of the system, presenting a notification in a first manner that corresponds to the request to provide the notification; and in accordance with a determination (e.g., automatically and without human intervention) that the head wearable device and one of the one or more peripheral devices are in a second state based on second data from the one or more sensors (and/or electrical components (e.g., a Bluetooth connection, a Wi-Fi connection, a cellular connection, etc.)) of the system, presenting a notification in a second manner that corresponds to the request to provide the notification.

For example, FIGS. 1A-1I and 2 illustrate interactions where a system, where depending on the state of the system, is configured to present notifications across different modalities.

In some embodiments, the one or more sensors of the system include a global position system (GPS) sensor that can determine location of a user as compared to map data, such that the system can be configured to provide notifications and alerts based on the location of the user (e.g., notifications can be provided without audio if the system is located at a library). In some embodiments, the GPS can also be used to determine an activity being performed (e.g., in transit, walking, driving, flying, etc.).

In some embodiments, the one or more sensors of the system include an inertial measurement sensor that can provide movement data of a user such that the system can be configured to provide notifications and/or alerts based on the movement of the user (e.g., if IMU data indicates the user is walking a visual notification may not be presented to avoid interrupting the user's path). In some embodiments, GPS data is combined with IMU data to be used to determine if a user is in a vehicle (e.g., high rate of speed, but no movement detected). In other words, IMU data can be used to determine walking status as well as detecting physical activity more generally. For example, FIG. 1H illustrates an in interaction where the device can determine at least partially based on IMU data that the user is walking around. In some embodiments, additional visual information, including information adapted to complement the walking experience can be presented to the user 100 when IMU data indicates that walking is occurring, e.g., navigational cues, landmark information, and/or warnings for dangers.

In some embodiments, the one or more sensors of the system include a microphone that in conjunction with a processing component is configured to determine if the user is in different environments, participating in a conversation, and/or determining the contents of the conversation. In some embodiments, from the microphone data it can be determined if a conversation is a high priority conversation (e.g., about a medical condition) as opposed to a passing low priority conversation (e.g., a discussion about the weather). For example, FIG. 1B illustrates an in interaction where the device can determine at least partially based on microphone data that the user is partaking in a conversation.

In some embodiments, the one or more sensors includes a camera (e.g., an egocentric camera) that in conjunction with a processing component is configured to determine certain interactions the user is partaking in (e.g., using a white board in a classroom (visually non-disruptive environment), conversing with someone (presence of people's faces), walking along a busy street such as crossing an intersection). In some embodiments, the camera along with the processing component is configured to determine background saliency (i.e., complexity of what the user is seeing), the presence of text (e.g., street sign name), and detecting the topic of what is being read by a user. In some embodiments, an eye tracking camera is also utilized as one of the sensors to also provide a determination as to whether the user is in a visually cluttered environment (e.g., the user is at a busy street fair and their eyes are shifting in position frequently and they are experiencing a high visual load). In some embodiments, the eye tracking camera can be used in conjunction with the other cameras to determine what the user is looking at (e.g., a person, text, etc.).

In some embodiments, the use of hand tracking can be used to determine the presence of physical activity (e.g., cutting vegetables, holding something carefully, etc.), the user has a demanding pose, etc.

In some embodiments, the information provided can extend beyond a notification. For example, the user can be watching a video, but then walking is detected and the video may switch to audio only playback such that the user's field of view is not disrupted by the video that was once playing. When walking is no longer detected the visual component of the video can be resumed. While one example is described, many other example are envisioned in which the output of media and other content unrelated to notifications can be altered based on determined activities and environments. For example, a book application may display text at a headset, however, as the user begins to commute to work, via bicycle or car, the book transitions from being displayed visually to being presented auditorily. In some embodiments, the operating system handles these modality transitions and developers of applications for the system do not need to program such features for each application, e.g., a developer may mark a UI augment as being video, images, text content and the operating system is then configured to change the modality and device to present as needed.

In some embodiments, the information provided in a notification can vary based on the modality in which it is being presented, e.g., a wrist-wearable device can be configured to present a short form of a notification and the extended-reality headset can be configured to present a long version of the notification (e.g., a wrist-wearable device may just state “New message from John” whereas an extended-reality headset can include “New message from John” and the associated body of message). The format of the information presented to the wearer is determined by the modality, user task, and/or user attention required for the incoming notification. For example, a more important message that requires more attention from the user would be presented in a longer format, which would be more suitable for presentational at a head-wearable device. On the other hand, a less urgent message that only requires a short alert would be more suitable for presentation at a wrist-wearable device.

In some embodiments, the modality in which the alert can be presented can be based partially on application category as well. In some embodiments, if multiple modalities are used the notification alert in each modality can contain less information than if only a single modality is used (e.g., a visual only notification may be more information rich than a visual notification that is presented with an audio notification).

In some embodiments, the pose and orientation of the devices in the system can dictate which device the notification is presented on. For example, if a phone or laptop display are within the immediate view of a camera of the headset, then the device may determine that presenting the alert on the phone or laptop display is more appropriate.

In some embodiments, long audio outputs should be provided when the value of the alert is very high (e.g., an incoming severe weather alert, etc.). In some embodiments, the value of an alert is at least partially determined by user preference and pattern recognition. For example, if a user starts an audiobook it is determined that an audiobook should be continued to be played even if it is not a high priority notification. In some embodiments, redundant modalities should be used only in specific settings, like under time pressure (e.g., your taxi has arrived). In some embodiments, if a notification is provided using a first modality, subsequent related notification should be provided in the same modality to avoid confusion (e.g., transitioning from providing alerts from the watch to the phone should be avoided).

In another example, the system can be configured to provide additional contextual information beyond notifications based on a surrounding environment. In some embodiments, the contextual information is determined using data provided by the camera, including image recognition. In one example, a user of the system can be viewing a poster on a wall and the system can be configured to receive an input (e.g., a user provides a verbal query asking about they are seeing, a user provides a physical input (e.g., a pinch gesture is detected), etc.) to find out more information about what they are viewing. In response to the input, the system is configured to provide an output at one or more devices of the system. For example, when a voice input is received the system is configured to present a response as an audio notification at the head-wearable device and optionally also present a haptic at a wrist-wearable device and displays a visual that includes text and or images to the user (e.g., displayed at the head-wearable device and/or the wrist wearable device). In some embodiments, if the system determines that a response could include media (e.g., images music, video, etc.) the system can provide the media to the user (e.g., after looking at a poster of a music artist, the device may state basic information about the musician and then provide a brief playback of their most popular song or playback of a music video). While these examples are shown many other options are possible, e.g., a user looks at a painting and the device output similar information, the user looks at an advertisement with a phone number and the system either initiates a voice of video call, the user looks in a pantry and asks foe recipe recommendations or for a snack, a user is provided with meeting information after being queried about an upcoming meeting, etc.

While many examples are described in this application, they are not exhaustive and are illustrative of the underlying architecture of presenting notifications across different modalities based on the situation the system is being used in. Additionally, the examples described in this application are all combinable and features of one embodiment are conceived as being combined with features of the other embodiments.

Being able to dynamically adjust how and when notifications and other information (e.g., media) are provided to the user based on external factors such as environment, activity, location, etc., help reduce unwanted interactions with the system configured to provide notifications to the user. By reducing unwanted interactions the user no longer needs to manually adjust how notifications are presented to them (e.g., by going to into settings user interfaces). In addition, by dynamically adjusting how notifications are received, the user is more likely to be notified of a notification, as opposed to missing it. Furthermore, in a system that includes multiple electronic devices that are all configured to provide notifications, having too many notifications can become an issue along with confusing the user as to what each notification means. Thus, it is beneficial to have a system that controls these notifications in concert with one another and provides notifications in the most efficient manner possible. In summary, this system reduces setting interactions required by the user, improves battery life by not having excess notifications, and provides a better user experience.

(A2) In some embodiments of A1, the first data from the one or more sensors is retrieved from a microphone of the system (e.g., a microphone of the head-wearable device). In some embodiments, second data from the one or more sensors is retrieved from the microphone of the system. For example, FIG. 1B illustrates an interaction where the device can determine at least partially based on microphone data that the user is partaking in a conversation.

(A3) In some embodiments of A2, the first data includes information from the microphone indicating a conversation is occurring with a wearer of the system, and presenting the notification in the first manner includes not presenting the notification. In some embodiments, the notification is not presented until after a determination is made that the conversation is no longer occurring. For example, FIG. 1B illustrates an in interaction where the device can determine at least partially based on microphone data that the user is partaking in a conversation.

(A4) In some embodiments of any of A2-A3, the first data includes information indicating a conversation is occurring with a wearer of the system, and presenting the notification in a non-audio-based manner (e.g., a haptic alert or a visual alert). In some embodiments, by not displaying the alert in an audio-based manner it does not interfere with an ongoing conversation, and is thereby less distracting to the wearer. In some embodiments, the haptic alert can be provided across multiple devices, e.g., a haptic can be provided at both the head-wearable device and a wrist-wearable device, or a phone, etc. For example, FIG. 1C shows a user finishing up a conversation, and the notification 110 is displayed visually and not auditorily.

(A5) In some embodiments of any of A2-A4, the first data includes information from the microphone indicating the system is in a loud environment, and presenting the notification in a non-audio-based manner (e.g., a haptic alert or a visual alert). FIG. 1A illustrates a user in a loud café and the notification (i.e., XR augment 103) is presented visually.

(A6) In some embodiments of any of A1-A5 the first data from the one or more sensors is retrieved from a camera of the system (e.g., an environment facing camera (e.g., a SLAM camera) of the head-wearable device). In some embodiments, second data from the one or more sensors is retrieved from the camera of the system. For example, FIG. 1B shows that a conversation can be detected at least based on a camera identifying that a person is talking and facing the user 100 of the head-worn device 102.

(A7) In some embodiments of any A1-A6, the first data from the one or more sensors is retrieved from a GPS of the system (e.g., a GPS of the head-wearable device). In some embodiments, second data from the one or more sensors is retrieved from the GPS of the system. For example, the GPS can indicate that the device is at a movie theater and preemptively silences notifications or provides non-audible notifications, such that the movie is not disrupted. For example, FIG. 1H shows the notifications 117 not being displayed visually as it is determined the user 100 is walking in a dangerous location and disrupting their view of the environment can be dangerous.

(A8) In some embodiments of any A1-A7, the first data from the one or more sensors is retrieved from an inertial measurement sensor of the system. For example, if the system determines based on IMU data that a user is walking, exercising, or performing an activity that may include vibration, a haptic feedback may not be provided as it may not be felt by the user. Instead a visual and/or auditory notification can provide in lieu of the haptic feedback. For example, FIG. 1H illustrates an in interaction where the device can determine at least partially based on IMU data that the user is walking around.

(A9) In some embodiments of A1-A8, presenting the notification in the first manner includes presenting the notification using multiple notification modalities (e.g., a combination of haptic, visual, auditory notifications). In some embodiments, the notification modalities can occur concurrently. In some embodiments, the notification modalities can occur across multiple devices (e.g., a visual notification at the head-worn device, and a haptic feedback at a wrist-wearable device, and/or an auditory feedback from earbuds or a smart speaker nearby). For example FIGS. 1E, 1G and 2 all show notifications being presented across multiple modalities (e.g., at different devices and/or different types of notifications).

(A10) In some embodiments of any of A1-A9, presenting the notification in the first manner includes presenting the notification using a haptic feedback generator of one of the one or more peripherals. For example, FIG. 1E shows a haptic feedback 113 being provided at a wrist-wearable device 108.

(A11) In some embodiments of any of A1-A10, presenting the notification in the first manner includes presenting the notification using a display (e.g., a waveguide) of the head-wearable device. For example, FIG. 1E also shows that an XR augment 111 is presented to the user 100 via the head-worn device 102.

(A12) In some embodiments of any of A1-A11 the system is further configured to, in response to receiving the request to provide the notification: in accordance with a determination that the notification is a high priority notification (e.g., a detection that food is burning and a fire can occur, an alarm is set off, or something is left behind, etc.), providing the notification irrespective of sensor data received. In some embodiments, the notification is provided across multiple devices and uses multiple notification modalities to provide the notification such that it is not missed. For example, FIG. 2 illustrates a high priority notification being presented across multiple modalities.

(A13) In some embodiments of any of A1-A12, one of the one or more peripherals is a wrist-wearable device configured to provide the notification through at least one notification modality, wherein the notification modalities include haptic feedback, auditory feedback, and visual feedback. In some embodiments, the wrist-wearable device includes a display configured to provide the notification the user. In some embodiments, the wrist-wearable device includes a haptic feedback generator configured to alert the user of the notification. In some embodiments, the haptic feedback can provide information by providing specific haptics for specific notifications (e.g., two short haptics can indicate a message notification). In some embodiments, the wrist-wearable device is configured to play an audible alert or read aloud the notification via a speaker located at the wrist-wearable device. In some embodiments, the wrist-wearable device includes one or more bio-potential sensors configured to interact with the wrist-wearable device, the other peripherals and the head-wearable device. For example, FIGS. 1A-1I illustrate a system that includes a wrist-wearable device 108.

(A14) In some embodiments of any of A1-A13, the head-wearable device is configured to provide a notification through at least one notification modality, wherein the notification modalities include haptic feedback, auditory feedback, and visual feedback. In some embodiments, the head-wearable device provides a visual notification through the use of a waveguide in an augmented-reality system (e.g., a text notification overlaying the surrounding environment). In some embodiments, the head-wearable device includes a speaker (e.g., a speaker around the ear, a bone conducting speaker, etc.) configured to present an auditory alert to the wearer. In some embodiments, the head-wearable device includes a haptic feedback generator for providing haptic feedback to the user to notify them of a notification. For example, non-visual notifications may be beneficial when bright light is detected and the display is not able to provide sufficient contrast to properly show the visual notification. For example, FIGS. 1A-1I illustrate a system that includes a head-wearable device 102.

(A15) In some embodiments of any of A1-A14, the first manner includes providing the notification at time later than when the request to provide the notification was received. For example, the notification can be delayed until an activity causing the delay has been completed (e.g., walking across a busy intersection that requires the user's full attention, the user is driving, studying, working, an application requiring the user's attention is being used (e.g., a video call), etc.), or a predefined time period has passed (e.g., 30 seconds, 5 minutes, 1 hour, 1 day etc.). For example, FIG. 1B shows that since a conversation is detected the notification indicating that a drink is ready is not presented to the user until after the conversation has ended.

(B1) In accordance with some embodiments, a head-wearable device in communication with one or more peripheral devices is configured to present notifications in accordance with any of A1-A15.

(C1) In accordance with some embodiments, a peripheral device (e.g., a wrist-wearable device, an intermediary processing device, a cellular device, a tablet device) that is in communication with a head-wearable device is configured to present notifications in accordance with any of A1-A15.

(D1) A non-transitory computer-readable storage medium storing one or more programs, the one or more programs comprising instructions that when executed by a system that includes a head-wearable device (e.g., an extended-reality headset such as an augmented reality headset) that is in communication with one or more peripherals (e.g., a wrist-wearable device, an intermediary processing device, a cellphone, etc.), causes the system to perform or cause performance of receiving a request to provide a notification (e.g., a notification from an application, such as a reminder application, an order notification, a message notification, etc.). The non-transitory computer-readable storage medium storing one or more programs, the one or more programs comprising instructions that when executed by the system, further causes the system to perform or cause performance of in response to receiving the request to provide the notification: in accordance with a determination (e.g., automatically and without human intervention) that the head wearable device and one of the one or more peripheral devices are in a first state based on first data from one or more sensors (and/or electrical components (e.g., a Bluetooth connection, a Wi-Fi connection, a cellular connection, etc.)) of the system, presenting a notification in a first manner that corresponds to the request to provide the notification; and in accordance with a determination (e.g., automatically and without human intervention) that the head wearable device and one of the one or more peripheral devices are in a second state based on second data from the one or more sensors (and/or electrical components (e.g., a Bluetooth connection, a Wi-Fi connection, a cellular connection, etc.)) of the system, presenting a notification in a second manner that corresponds to the request to provide the notification.

(D2) In some embodiments of D1, the one or more programs further comprise instructions for performing or causing performance of any of the features of A1-A15.

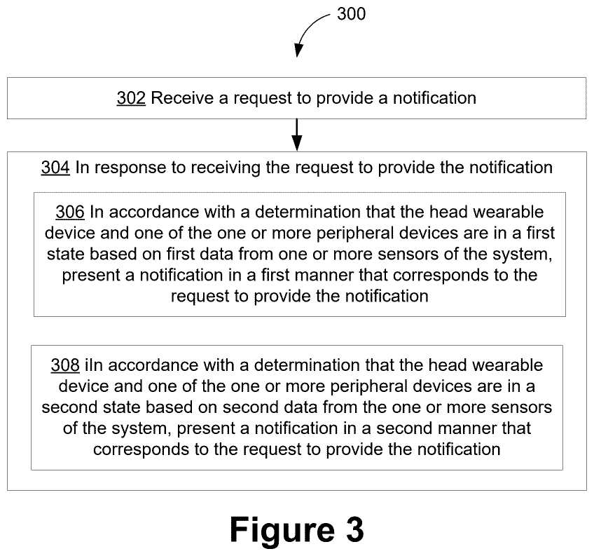

The method described in reference to A1 described below is shown in FIG. 3 as method 300. (E1) In accordance with some embodiments, a method for controlling notification outputs occurs at a head-wearable device (e.g., an extended-reality headset such as an augmented reality headset) that is in communication with one or more peripherals (e.g., a wrist-wearable device, an intermediary processing device, a cellphone, etc.). The method comprises, receiving (302) a request to provide a notification (e.g., a notification from an application, such as a reminder application, an order notification, a message notification, etc.), and in response to receiving the request to provide the notification: in accordance with a determination (e.g., automatically and without human intervention) that the head wearable device and one of the one or more peripheral devices are in a first state based on first data from one or more sensors (and/or electrical components (e.g., a Bluetooth connection, a Wi-Fi connection, a cellular connection, etc.)) of the system, presenting a notification in a first manner that corresponds to the request to provide the notification; and in accordance with a determination (e.g., automatically and without human intervention) that the head wearable device and one of the one or more peripheral devices are in a second state based on second data from the one or more sensors (and/or electrical components (e.g., a Bluetooth connection, a Wi-Fi connection, a cellular connection, etc.)) of the system, presenting a notification in a second manner that corresponds to the request to provide the notification.

(E2) In some embodiments of E1, the method is configured in accordance with any of claims A1-A15.

(F1) In accordance with some embodiments, a system for selecting output modalities for notifications based on situational awareness, comprises a head-wearable device that is in communication with a mobile device different from the head-wearable device. The system is configured to, in response to receiving a request to output a first notification, obtaining first sensor data from the head-wearable device and the mobile device used to determine a physical-environment characteristic for an environment in which a user of the head-wearable device is located. The system is configured to, based on the physical-environment characteristic, determining a first output modality at the head-wearable device or the mobile device for presenting the first notification to the user. The system is configured to, in response to receiving a request to output a second notification that is a of a distinct type from the first notification, obtaining second sensor data from the head-wearable device and the mobile device used to determine a new physical-environment characteristic for an environment in which a user of the head-wearable device is located. The system is configured to, based on the new physical-environment characteristic, determining a new output modality, distinct from the first output modality, at the head-wearable device or the mobile device for presenting the second notification to the user.

(F2) In some embodiments of F1, the first sensor data includes data from a microphone of the system.

(F3) In some embodiments of F2, the first sensor data includes information from the microphone indicating a conversation is occurring with the user, and presenting the first notification includes delaying presentation of the first notification until after the conversation has been determined to be concluded.

(F4) In some embodiments of F2, the first sensor data includes information indicating a conversation is occurring with the user, and the first output modality is a non-audio-based output modality.

(F5) In some embodiments of F2, the first sensor data includes information from the microphone indicating the system is in a loud environment, and the first output modality is a non-audio-based output modality.

(F6) In some embodiments of any of F1-F5, the first sensor data includes data that is retrieved from a camera of the system.

(F7) In some embodiments of any of F1-F6, the first sensor data includes data that is retrieved from a global position system (GPS) of the system.

(F8) In some embodiments of any of F1-F7, the first sensor data from the one or more sensors is retrieved from an inertial measurement sensor of the system.

(F9) In some embodiments of any of F1-F8, the first output modality includes presenting the first notification via multiple output modalities of the system.

(F10) In some embodiments of any of F1-F9, presenting the first notification to the user includes providing a haptic feedback provided by a haptic feedback generator of the head-wearable device or the mobile device.

(F11) In some embodiments of any of F1-F10, the first output modality includes presenting the first notification using a display of the head-wearable device.

(F12) In some embodiments of any of F1-F11, the system is further configured to:
in response to receiving the request to output a third notification different from the first notification and the second notification:
   in accordance with a determination that the third notification is a high priority notification, providing the third notification irrespective of another determined physical-environment characteristic of an environment.

(F13) In some embodiments of any of F1-F12, the mobile device is a wrist-wearable device, and the first output modality is one or more of a haptic feedback, an auditory feedback, and a visual feedback.

(F14) In some embodiments of any of F1-F13, the first notification is provided at time later than when the request to provide the notification was received.

(G1) In accordance with some embodiments, a non-transitory computer-readable storage medium storing one or more programs, the one or more programs comprising instructions that when executed by a system that includes a head-wearable device that is in communication with a mobile device, cause the system to perform or cause performance of, in response to receiving a request to output a first notification, obtaining first sensor data from the head-wearable device and the mobile device used to determine a physical-environment characteristic for an environment in which a user of the head-wearable device is located. The one or more programs also cause the system to perform or cause performance of, based on the physical-environment characteristic, determining a first output modality at the head-wearable device or the mobile device for presenting the first notification to the user. The one or more programs also cause the system to perform or cause performance of, in response to receiving a request to output a second notification that is a of a distinct type from the first notification, obtaining second sensor data from the head-wearable device and the mobile device used to determine a new physical-environment characteristic for an environment in which a user of the head-wearable device is located. The one or more programs also cause the system to perform or cause performance of, based on the new physical-environment characteristic, determining a new output modality, distinct from the first output modality, at the head-wearable device or the mobile device for presenting the second notification to the user.

(G2) In some embodiments of G1, the system is configured in accordance with any one of F1-F14.

(H1) In accordance with some embodiments, a method for selecting output modalities for notifications based on situational awareness occurs at a system that includes a head-wearable device that is in communication with a mobile device different from the head-wearable device. The method comprises in response to receiving a request to output a first notification: obtaining first sensor data from the head-wearable device and the mobile device used to determine a physical-environment characteristic for an environment in which a user of the head-wearable device is located, and based on the physical-environment characteristic, determining a first output modality at the head-wearable device or the mobile device for presenting the first notification to the user. The method also includes in response to receiving a request to output a second notification that is a of a distinct type from the first notification: obtaining second sensor data from the head-wearable device and the mobile device used to determine a new physical-environment characteristic for an environment in which a user of the head-wearable device is located, and based on the new physical-environment characteristic, determining a new output modality, distinct from the first output modality, at the head-wearable device or the mobile device for presenting the second notification to the user.

In some embodiments of H1, the system is configured in accordance with any one of F1-F14.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device 500, a head-wearable device, an HIPD 700, a smart textile-based garment 800, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., virtual-reality animations, such as three-dimensional modeling); (iv) a field-programmable gate array (FPGA) that can be programmed and reconfigured after manufacturing and/or customized to perform specific tasks, such as signal processing, cryptography, and machine learning; (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or DSPs. As described herein, a graphics module is a component or software module that is designed to handle graphical operations and/or processes, and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include: (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) POGO pins, which may be small, spring-loaded pins configured to provide a charging interface; (v) wireless charging interfaces; (vi) global-position system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device); (ii) biopotential-signal sensors; (iii) inertial measurement unit (e.g., IMUs) for detecting, for example, angular rate, force, magnetic field, and/or changes in acceleration; (iv) heart rate sensors for measuring a user's heart rate; (v) SpO2 sensors for measuring blood oxygen saturation and/or other biometric data of a user; (vi) capacitive sensors for detecting changes in potential at a portion of a user's body (e.g., a sensor-skin interface) and/or the proximity of other devices or objects; and (vii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include: (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) electromyography (EMG) sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications, (x) camera applications, (xi) web-based applications; (xii) health applications; (xiii) artificial-reality (AR) applications, and/or any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). In some embodiments, a communication interface can refer to a software layer that enables different software programs to communicate with each other (e.g., application programming interfaces (APIs) and protocols such as HTTP and TCP/IP).

As described herein, a graphics module is a component or software module that is designed to handle graphical operations and/or processes, and can include a hardware module and/or a software module.

As described herein, non-transitory computer-readable storage media are physical devices or storage medium that can be used to store electronic data in a non-transitory form (e.g., such that the data is stored permanently until it is intentionally deleted or modified).

### Example AR Systems

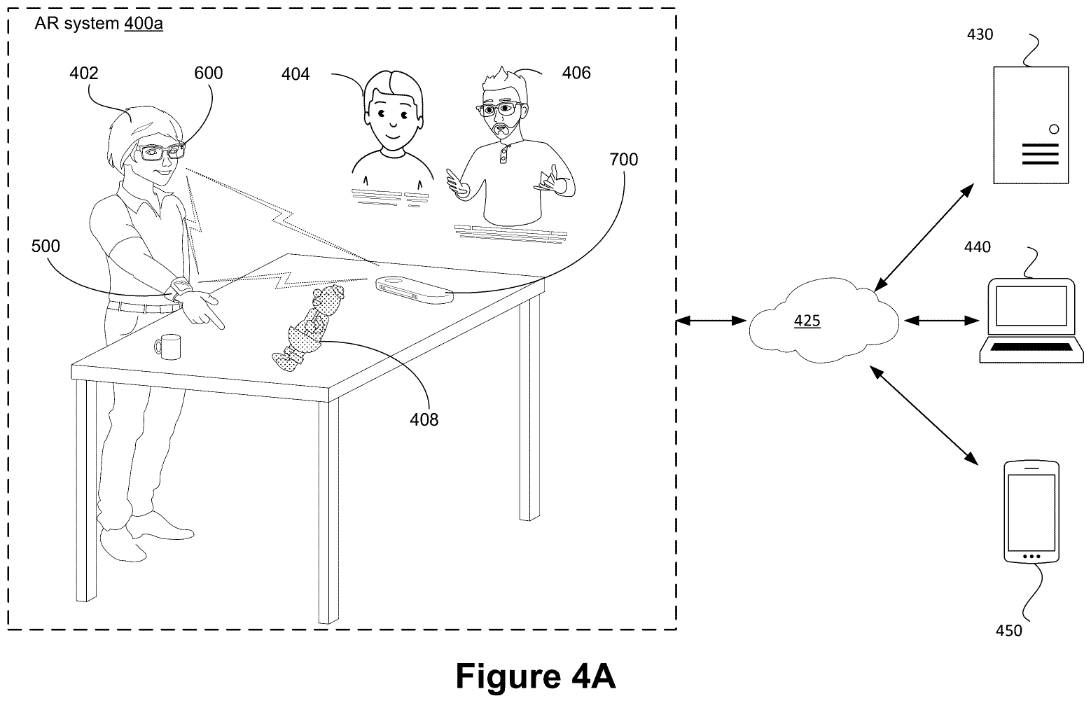

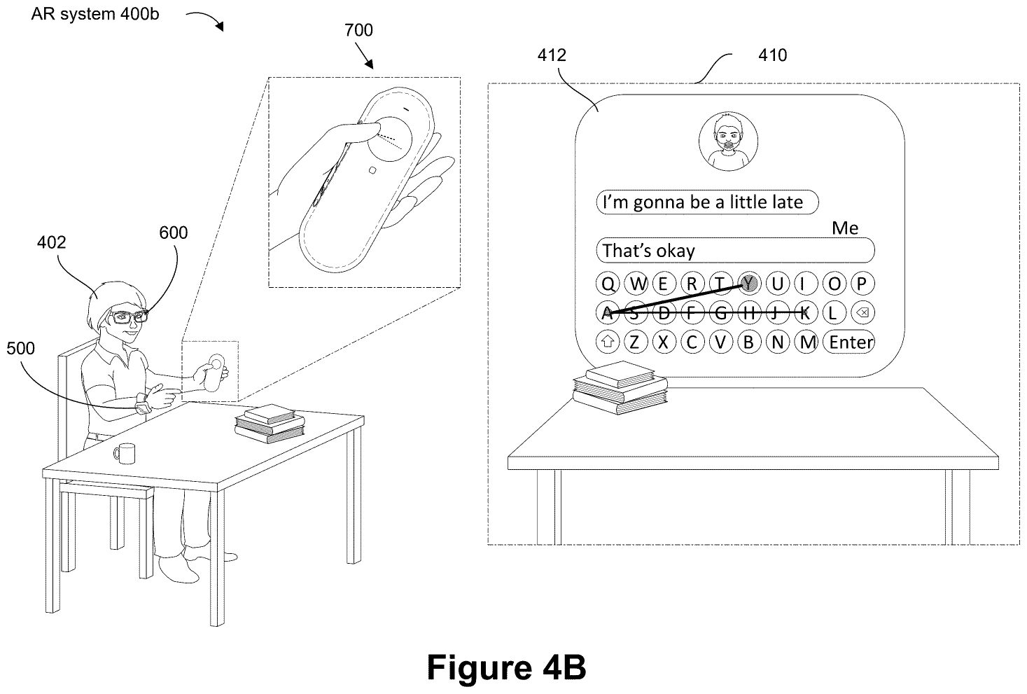

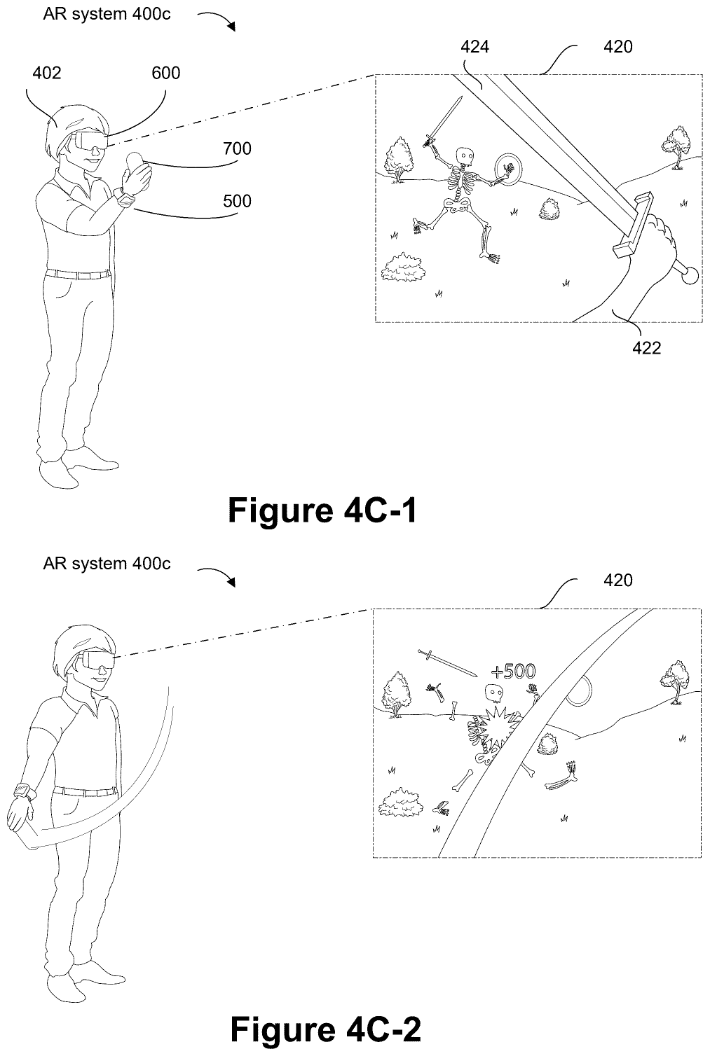

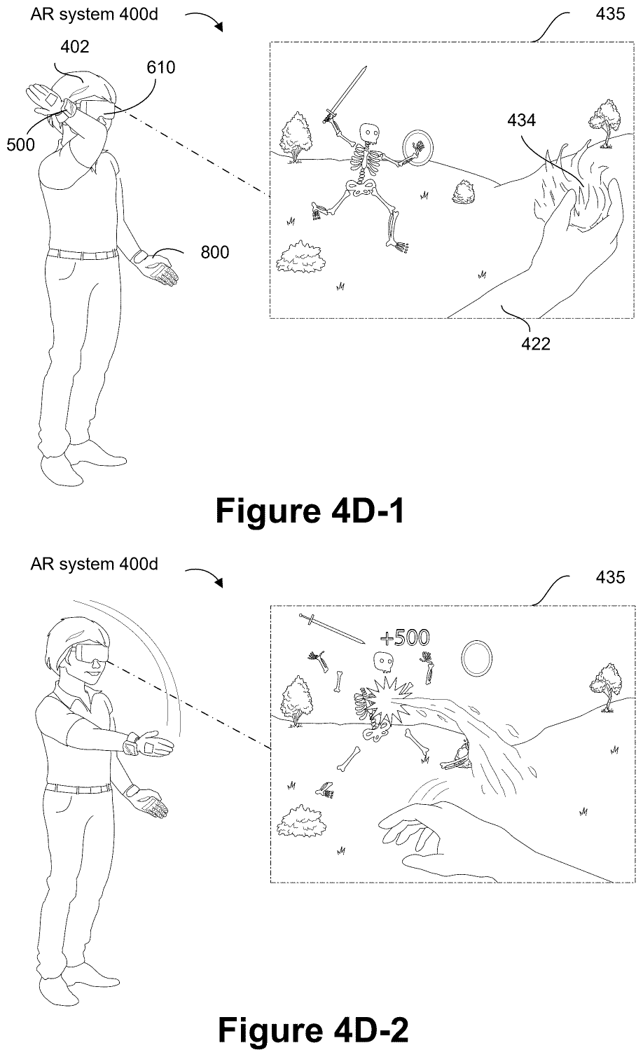

FIGS. 4A, 4B, 4C-1, 4C-2, 4D-1, and 4D-2 illustrate example artificial-reality systems, in accordance with some embodiments. FIG. 4A shows a first AR system 400a and first example user interactions using a wrist-wearable device 500, a head-wearable device (e.g., AR device 600), and/or a handheld intermediary processing device (HIPD) 700. FIG. 4B shows a second AR system 400b and second example user interactions using a wrist-wearable device 500, AR device 600, and/or an HIPD 700. FIGS. 4C-1 and 4C-2 show a third AR system 400c and third example user interactions using a wrist-wearable device 500, a head-wearable device (e.g., virtual-reality (VR) device 610), and/or an HIPD 700. FIGS. 4D-1 and 4D-2 show a fourth AR system 400d and fourth example user interactions using a wrist-wearable device 500, VR device 610, and/or a smart textile-based garment 800 (e.g., wearable gloves haptic gloves). As the skilled artisan will appreciate upon reading the descriptions provided herein, the above-example AR systems (described in detail below) can perform various functions and/or operations described above with reference to FIGS. 1A-3.

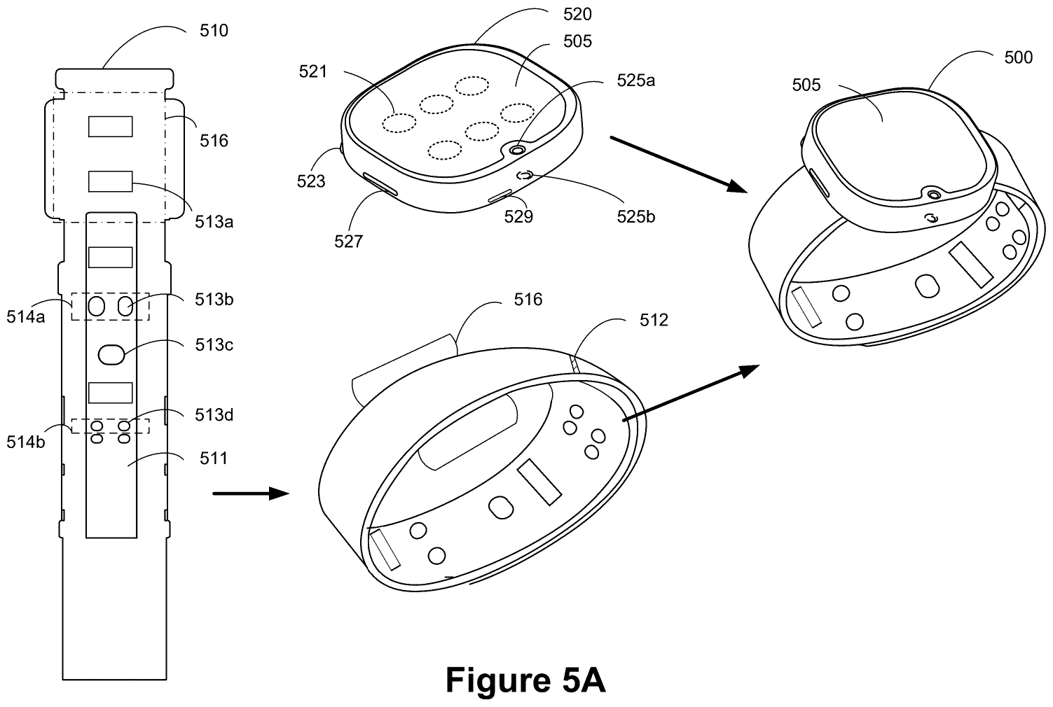

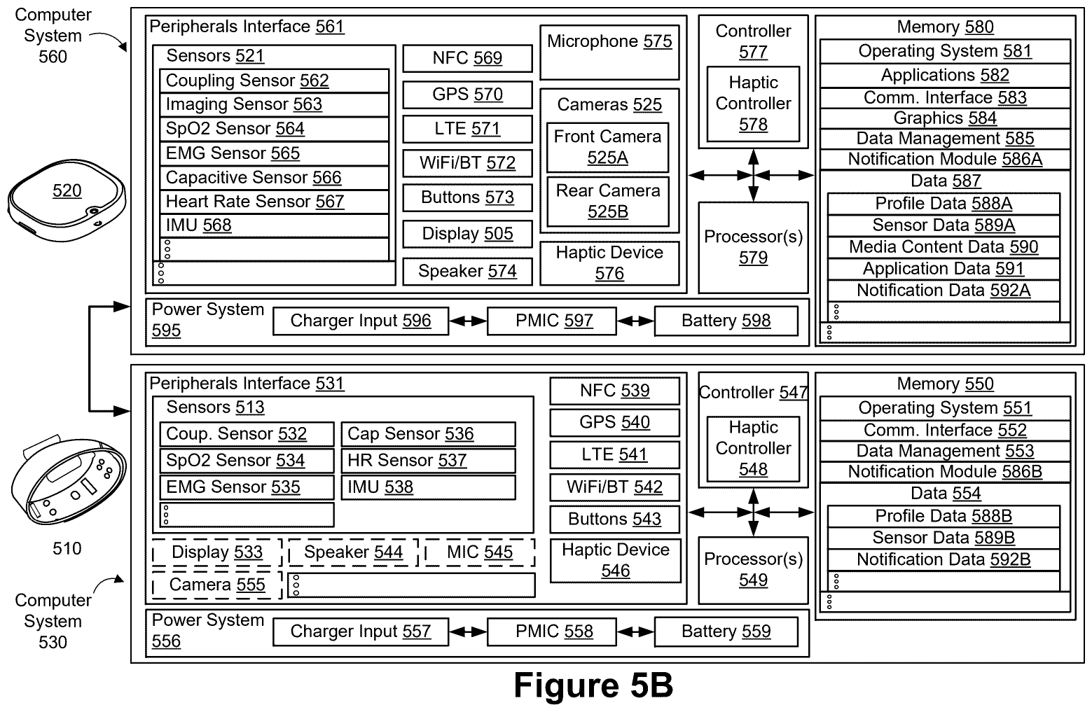

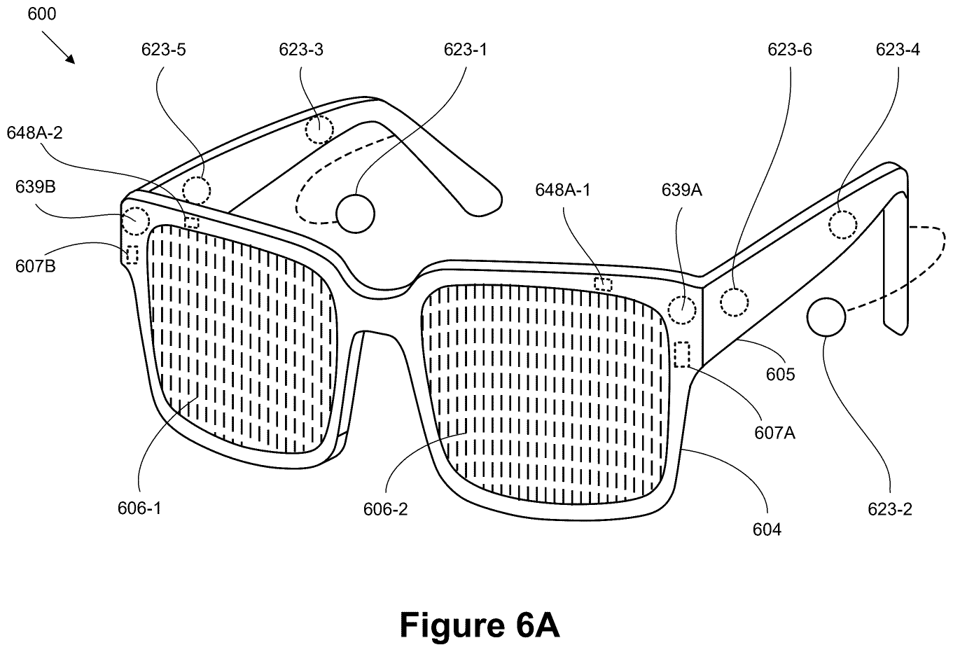

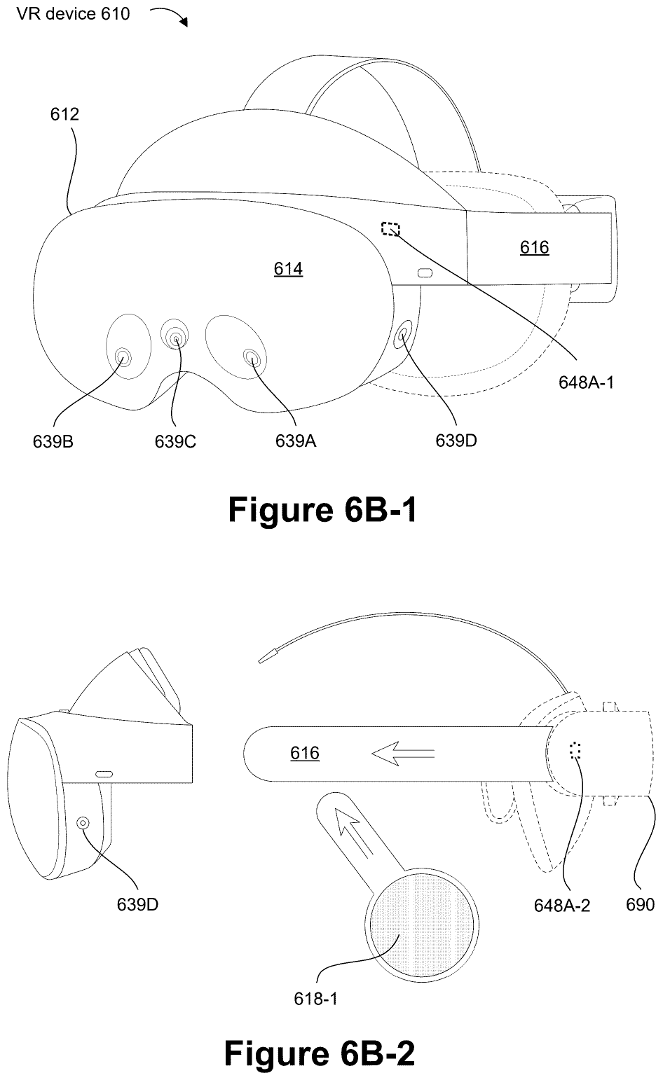

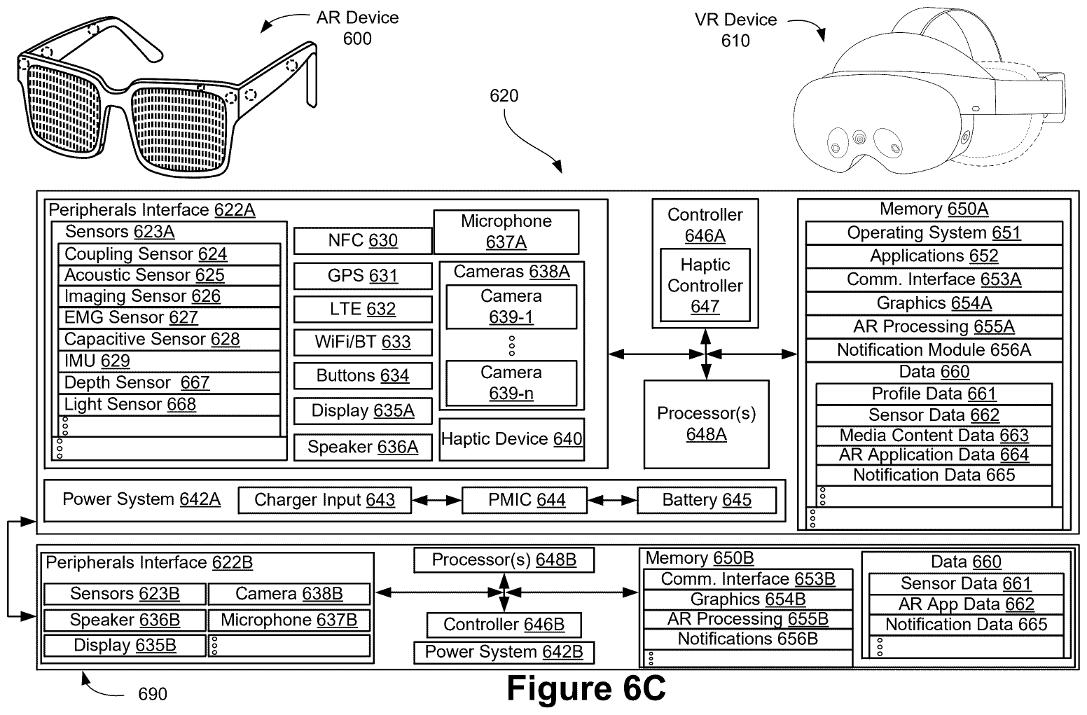

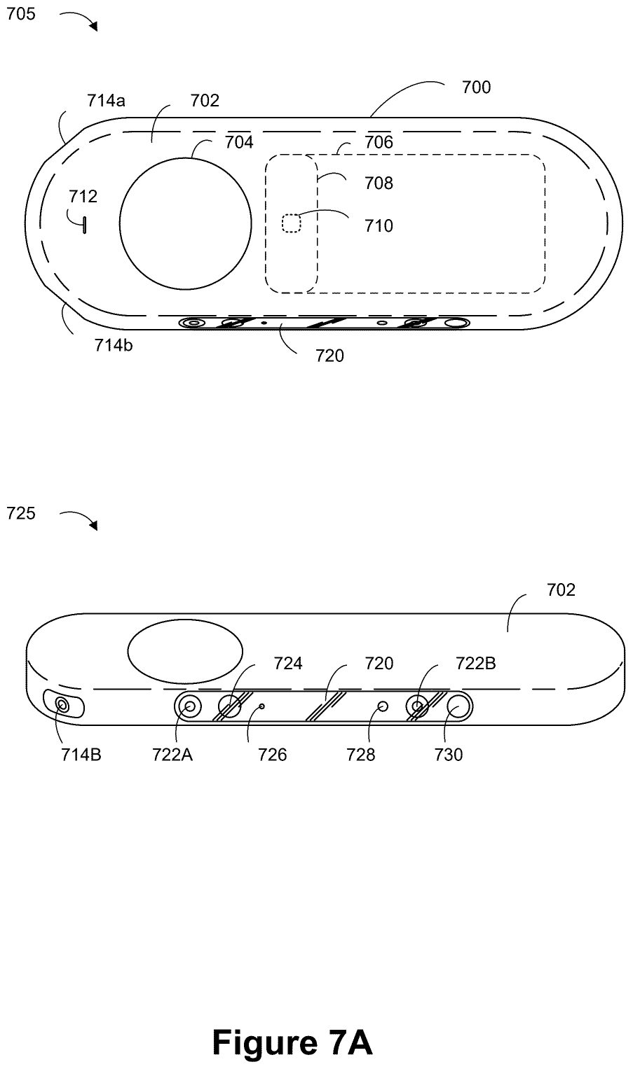

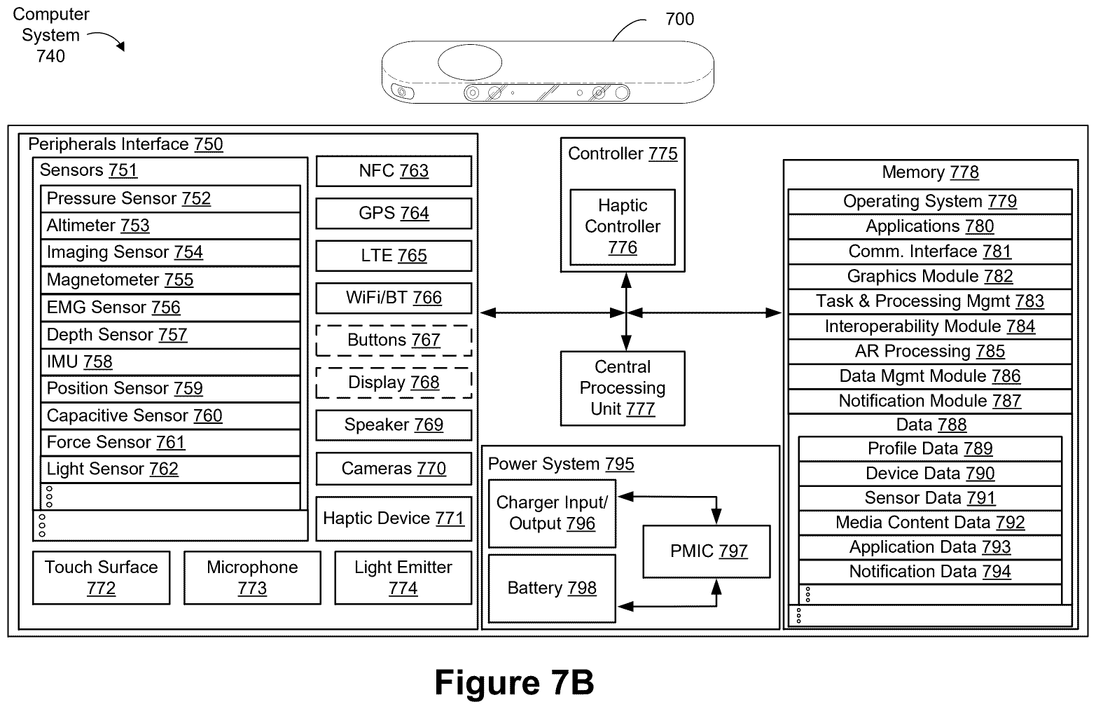

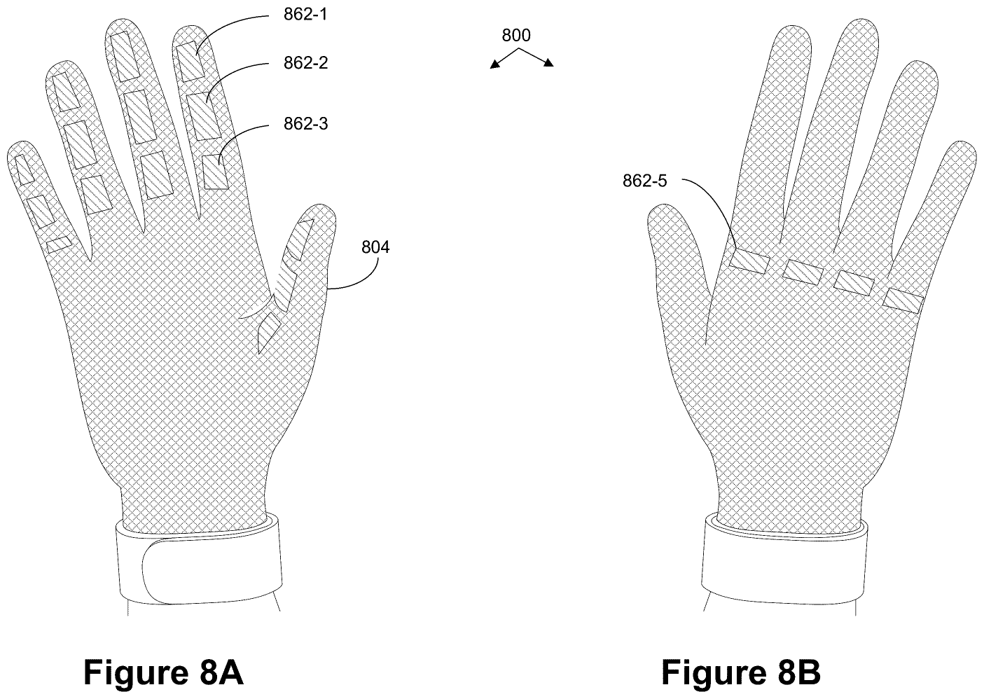

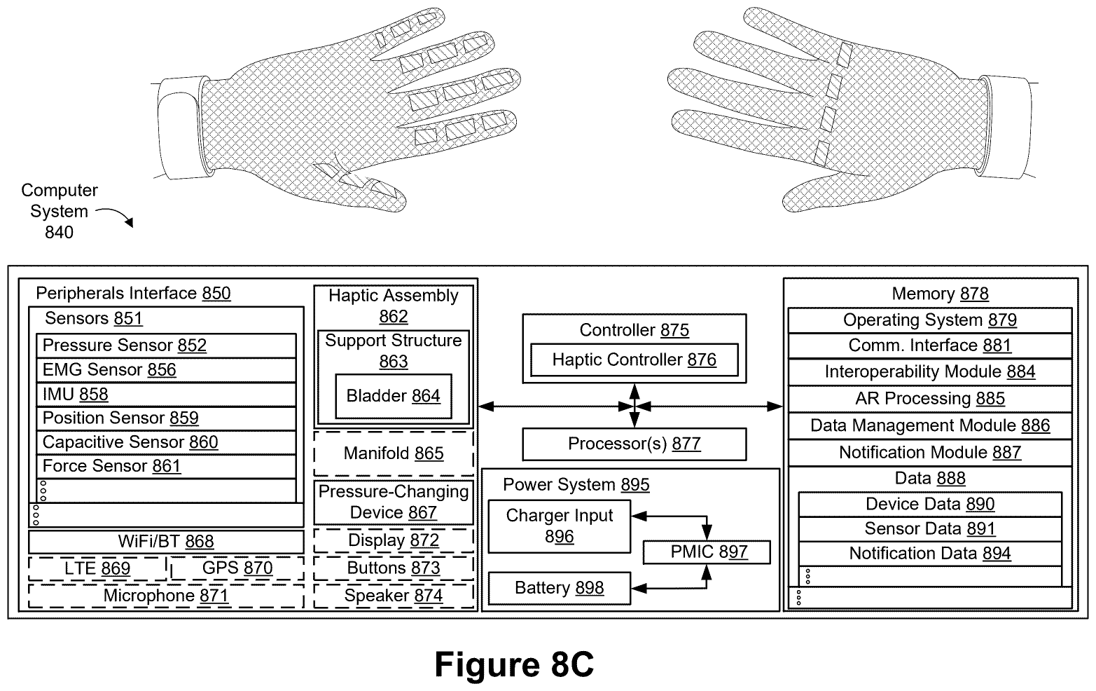

The wrist-wearable device 500 and its constituent components are described below in reference to FIGS. 5A-5B, the head-wearable devices and their constituent components are described below in reference to FIGS. 6A-6D, and the HIPD 700 and its constituent components are described below in reference to FIGS. 7A-7B. The smart textile-based garment 800 and its one or more components are described below in reference to FIGS. 8A-8C. The wrist-wearable device 500, the head-wearable devices, and/or the HIPD 700 can communicatively couple via a network 425 (e.g., cellular, near field, Wi-Fi, personal area network, wireless LAN, etc.). Additionally, the wrist-wearable device 500, the head-wearable devices, and/or the HIPD 700 can also communicatively couple with one or more servers 430, computers 440 (e.g., laptops, computers, etc.), mobile devices 450 (e.g., smartphones, tablets, etc.), and/or other electronic devices via the network 425 (e.g., cellular, near field, Wi-Fi, personal area network, wireless LAN, etc.). Similarly, the smart textile-based garment 800, when used, can also communicatively couple with the wrist-wearable device 500, the head-wearable devices, the HIPD 700, the one or more servers 430, the computers 440, the mobile devices 450, and/or other electronic devices via the network 425.

Turning to FIG. 4A, a user 402 is shown wearing the wrist-wearable device 500 and the AR device 600, and having the HIPD 700 on their desk. The wrist-wearable device 500, the AR device 600, and the HIPD 700 facilitate user interaction with an AR environment. In particular, as shown by the first AR system 400a, the wrist-wearable device 500, the AR device 600, and/or the HIPD 700 cause presentation of one or more avatars 404, digital representations of contacts 406, and virtual objects 408. As discussed below, the user 402 can interact with the one or more avatars 404, digital representations of the contacts 406, and virtual objects 408 via the wrist-wearable device 500, the AR device 600, and/or the HIPD 700.

The user 402 can use any of the wrist-wearable device 500, the AR device 600, and/or the HIPD 700 to provide user inputs. For example, the user 402 can perform one or more hand gestures that are detected by the wrist-wearable device 500 (e.g., using one or more EMG sensors and/or IMUs, described below in reference to FIGS. 5A-5B) and/or AR device 600 (e.g., using one or more image sensors or cameras, described below in reference to FIGS. 6A-6B) to provide a user input. Alternatively, or additionally, the user 402 can provide a user input via one or more touch surfaces of the wrist-wearable device 500, the AR device 600, and/or the HIPD 700, and/or voice commands captured by a microphone of the wrist-wearable device 500, the AR device 600, and/or the HIPD 700. In some embodiments, the wrist-wearable device 500, the AR device 600, and/or the HIPD 700 include a digital assistant to help the user in providing a user input (e.g., completing a sequence of operations, suggesting different operations or commands, providing reminders, confirming a command). In some embodiments, the user 402 can provide a user input via one or more facial gestures and/or facial expressions. For example, cameras of the wrist-wearable device 500, the AR device 600, and/or the HIPD 700 can track the user 402's eyes for navigating a user interface.

The wrist-wearable device 500, the AR device 600, and/or the HIPD 700 can operate alone or in conjunction to allow the user 402 to interact with the AR environment. In some embodiments, the HIPD 700 is configured to operate as a central hub or control center for the wrist-wearable device 500, the AR device 600, and/or another communicatively coupled device. For example, the user 402 can provide an input to interact with the AR environment at any of the wrist-wearable device 500, the AR device 600, and/or the HIPD 700, and the HIPD 700 can identify one or more back-end and front-end tasks to cause the performance of the requested interaction and distribute instructions to cause the performance of the one or more back-end and front-end tasks at the wrist-wearable device 500, the AR device 600, and/or the HIPD 700. In some embodiments, a back-end task is a background-processing task that is not perceptible by the user (e.g., rendering content, decompression, compression, etc.), and a front-end task is a user-facing task that is perceptible to the user (e.g., presenting information to the user, providing feedback to the user, etc.)). As described below in reference to FIGS. 7A-7B, the HIPD 700 can perform the back-end tasks and provide the wrist-wearable device 500 and/or the AR device 600 operational data corresponding to the performed back-end tasks such that the wrist-wearable device 500 and/or the AR device 600 can perform the front-end tasks. In this way, the HIPD 700, which has more computational resources and greater thermal headroom than the wrist-wearable device 500 and/or the AR device 600, performs computationally intensive tasks and reduces the computer resource utilization and/or power usage of the wrist-wearable device 500 and/or the AR device 600.

In the example shown by the first AR system 400a, the HIPD 700 identifies one or more back-end tasks and front-end tasks associated with a user request to initiate an AR video call with one or more other users (represented by the avatar 404 and the digital representation of the contact 406) and distributes instructions to cause the performance of the one or more back-end tasks and front-end tasks. In particular, the HIPD 700 performs back-end tasks for processing and/or rendering image data (and other data) associated with the AR video call and provides operational data associated with the performed back-end tasks to the AR device 600 such that the AR device 600 performs front-end tasks for presenting the AR video call (e.g., presenting the avatar 404 and the digital representation of the contact 406).

In some embodiments, the HIPD 700 can operate as a focal or anchor point for causing the presentation of information. This allows the user 402 to be generally aware of where information is presented. For example, as shown in the first AR system 400a, the avatar 404 and the digital representation of the contact 406 are presented above the HIPD 700. In particular, the HIPD 700 and the AR device 600 operate in conjunction to determine a location for presenting the avatar 404 and the digital representation of the contact 406. In some embodiments, information can be presented within a predetermined distance from the HIPD 700 (e.g., within five meters). For example, as shown in the first AR system 400a, virtual object 408 is presented on the desk some distance from the HIPD 700. Similar to the above example, the HIPD 700 and the AR device 600 can operate in conjunction to determine a location for presenting the virtual object 408. Alternatively, in some embodiments, presentation of information is not bound by the HIPD 700. More specifically, the avatar 404, the digital representation of the contact 406, and the virtual object 408 do not have to be presented within a predetermined distance of the HIPD 700.

User inputs provided at the wrist-wearable device 500, the AR device 600, and/or the HIPD 700 are coordinated such that the user can use any device to initiate, continue, and/or complete an operation. For example, the user 402 can provide a user input to the AR device 600 to cause the AR device 600 to present the virtual object 408 and, while the virtual object 408 is presented by the AR device 600, the user 402 can provide one or more hand gestures via the wrist-wearable device 500 to interact and/or manipulate the virtual object 408.

FIG. 4B shows the user 402 wearing the wrist-wearable device 500 and the AR device 600, and holding the HIPD 700. In the second AR system 400b, the wrist-wearable device 500, the AR device 600, and/or the HIPD 700 are used to receive and/or provide one or more messages to a contact of the user 402. In particular, the wrist-wearable device 500, the AR device 600, and/or the HIPD 700 detect and coordinate one or more user inputs to initiate a messaging application and prepare a response to a received message via the messaging application.

In some embodiments, the user 402 initiates, via a user input, an application on the wrist-wearable device 500, the AR device 600, and/or the HIPD 700 that causes the application to initiate on at least one device. For example, in the second AR system 400b the user 402 performs a hand gesture associated with a command for initiating a messaging application (represented by messaging user interface 412); the wrist-wearable device 500 detects the hand gesture; and, based on a determination that the user 402 is wearing AR device 600, causes the AR device 600 to present a messaging user interface 412 of the messaging application. The AR device 600 can present the messaging user interface 412 to the user 402 via its display (e.g., as shown by user 402's field of view 410). In some embodiments, the application is initiated and can be run on the device (e.g., the wrist-wearable device 500, the AR device 600, and/or the HIPD 700) that detects the user input to initiate the application, and the device provides another device operational data to cause the presentation of the messaging application. For example, the wrist-wearable device 500 can detect the user input to initiate a messaging application, initiate and run the messaging application, and provide operational data to the AR device 600 and/or the HIPD 700 to cause presentation of the messaging application. Alternatively, the application can be initiated and run at a device other than the device that detected the user input. For example, the wrist-wearable device 500 can detect the hand gesture associated with initiating the messaging application and cause the HIPD 700 to run the messaging application and coordinate the presentation of the messaging application.

Further, the user 402 can provide a user input provided at the wrist-wearable device 500, the AR device 600, and/or the HIPD 700 to continue and/or complete an operation initiated at another device. For example, after initiating the messaging application via the wrist-wearable device 500 and while the AR device 600 presents the messaging user interface 412, the user 402 can provide an input at the HIPD 700 to prepare a response (e.g., shown by the swipe gesture performed on the HIPD 700). The user 402's gestures performed on the HIPD 700 can be provided and/or displayed on another device. For example, the user 402's swipe gestures performed on the HIPD 700 are displayed on a virtual keyboard of the messaging user interface 412 displayed by the AR device 600.

In some embodiments, the wrist-wearable device 500, the AR device 600, the HIPD 700, and/or other communicatively coupled devices can present one or more notifications to the user 402. The notification can be an indication of a new message, an incoming call, an application update, a status update, etc. The user 402 can select the notification via the wrist-wearable device 500, the AR device 600, or the HIPD 700 and cause presentation of an application or operation associated with the notification on at least one device. For example, the user 402 can receive a notification that a message was received at the wrist-wearable device 500, the AR device 600, the HIPD 700, and/or other communicatively coupled device and provide a user input at the wrist-wearable device 500, the AR device 600, and/or the HIPD 700 to review the notification, and the device detecting the user input can cause an application associated with the notification to be initiated and/or presented at the wrist-wearable device 500, the AR device 600, and/or the HIPD 700.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 600 can present to the user 402 game application data and the HIPD 700 can use a controller to provide inputs to the game. Similarly, the user 402 can use the wrist-wearable device 500 to initiate a camera of the AR device 600, and the user can use the wrist-wearable device 500, the AR device 600, and/or the HIPD 700 to manipulate the image capture (e.g., zoom in or out, apply filters, etc.) and capture image data.

Turning to FIGS. 4C-1 and 4C-2, the user 402 is shown wearing the wrist-wearable device 500 and a VR device 610, and holding the HIPD 700. In the third AR system 400c, the wrist-wearable device 500, the VR device 610, and/or the HIPD 700 are used to interact within an AR environment, such as a VR game or other AR application. While the VR device 610 present a representation of a VR game (e.g., first AR game environment 420) to the user 402, the wrist-wearable device 500, the VR device 610, and/or the HIPD 700 detect and coordinate one or more user inputs to allow the user 402 to interact with the VR game.

In some embodiments, the user 402 can provide a user input via the wrist-wearable device 500, the VR device 610, and/or the HIPD 700 that causes an action in a corresponding AR environment. For example, the user 402 in the third AR system 400c (shown in FIG. 4C-1) raises the HIPD 700 to prepare for a swing in the first AR game environment 420. The VR device 610, responsive to the user 402 raising the HIPD 700, causes the AR representation of the user 422 to perform a similar action (e.g., raise a virtual object, such as a virtual sword 424). In some embodiments, each device uses respective sensor data and/or image data to detect the user input and provide an accurate representation of the user 402's motion. For example, image sensors 758 (e.g., SLAM cameras or other cameras discussed below in FIGS. 7A and 7B) of the HIPD 700 can be used to detect a position of the 700 relative to the user 402's body such that the virtual object can be positioned appropriately within the first AR game environment 420; sensor data from the wrist-wearable device 500 can be used to detect a velocity at which the user 402 raises the HIPD 700 such that the AR representation of the user 422 and the virtual sword 424 are synchronized with the user 402's movements; and image sensors 626 (FIGS. 6A-6C) of the VR device 610 can be used to represent the user 402's body, boundary conditions, or real-world objects within the first AR game environment 420.

In FIG. 4C-2, the user 402 performs a downward swing while holding the HIPD 700. The user 402's downward swing is detected by the wrist-wearable device 500, the VR device 610, and/or the HIPD 700 and a corresponding action is performed in the first AR game environment 420. In some embodiments, the data captured by each device is used to improve the user's experience within the AR environment. For example, sensor data of the wrist-wearable device 500 can be used to determine a speed and/or force at which the downward swing is performed and image sensors of the HIPD 700 and/or the VR device 610 can be used to determine a location of the swing and how it should be represented in the first AR game environment 420, which, in turn, can be used as inputs for the AR environment (e.g., game mechanics, which can use detected speed, force, locations, and/or aspects of the user 402's actions to classify a user's inputs (e.g., user performs a light strike, hard strike, critical strike, glancing strike, miss) or calculate an output (e.g., amount of damage)).

While the wrist-wearable device 500, the VR device 610, and/or the HIPD 700 are described as detecting user inputs, in some embodiments, user inputs are detected at a single device (with the single device being responsible for distributing signals to the other devices for performing the user input). For example, the HIPD 700 can operate an application for generating the first AR game environment 420 and provide the VR device 610 with corresponding data for causing the presentation of the first AR game environment 420, as well as detect the 402's movements (while holding the HIPD 700) to cause the performance of corresponding actions within the first AR game environment 420. Additionally or alternatively, in some embodiments, operational data (e.g., sensor data, image data, application data, device data, and/or other data) of one or more devices is provide to a single device (e.g., the HIPD 700) to process the operational data and cause respective devices to perform an action associated with processed operational data.

FIGS. 4D-1 and 4D-2, the user 402 is shown wearing the wrist-wearable device 500, the VR device 610, smart textile-based garments 800. In the fourth AR system 400d, the wrist-wearable device 500, the VR device 610, and/or the smart textile-based garments 800 are used to interact within an AR environment (e.g., any AR system described above in reference to FIGS. 4A-4C-2, as well as FIGS. 1A-3). While the VR device 610 present a representation of a VR game (e.g., second AR game environment 430) to the user 402, the wrist-wearable device 500, the VR device 610, and/or the smart textile-based garments 800 detect and coordinate one or more user inputs to allow the user 402 to interact with the AR environment.

In some embodiments, the user 402 can provide a user input via the wrist-wearable device 500, the VR device 610, and/or the smart textile-based garments 800 that causes an action in a corresponding AR environment. For example, the user 402 in the fourth AR system 400d (shown in FIG. 4D-1) raises a hand wearing the smart textile-based garments 800 to prepare for cast spell or throw an object within the second AR game environment 430. The VR device 610, responsive to the user 402 holding up their hand (wearing a smart textile-based garments 800), causes the AR representation of the user 422 to perform a similar action (e.g., hold a virtual object, such as a casting a fireball 434). In some embodiments, each device uses respective sensor data and/or image data to detect the user input and provide an accurate representation of the user 402's motion.

In FIG. 4D-2, the user 402 performs a throwing motion while wearing the smart textile-based garment 800. The user 402's throwing motion is detected by the wrist-wearable device 500, the VR device 610, and/or the smart textile-based garments 800 and a corresponding action is performed in the second AR game environment 430. As described above, the data captured by each device is used to improve the user's experience within the AR environment. Although not shown, the smart textile-based garments 800 can be used in conjunction with an AR device 610 and/or an HIPD 700.

Having discussed example AR systems, devices for interacting with such AR systems, and other computing systems more generally, will now be discussed in greater detail below. Some definitions of devices and components that can be included in some or all of the example devices discussed below are defined here for ease of reference. A skilled artisan will appreciate that certain types of the components described below may be more suitable for a particular set of devices, and less suitable for a different set of devices. But subsequent reference to the components defined here should be considered to be encompassed by the definitions provided.

In some embodiments discussed below example devices and systems, including electronic devices and systems, will be discussed. Such example devices and systems are not intended to be limiting, and one of skill in the art will understand that alternative devices and systems to the example devices and systems described herein may be used to perform the operations and construct the systems and device that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

### Example Wrist-Wearable Devices

FIGS. 5A and 5B illustrate an example wrist-wearable device 500, in accordance with some embodiments. The wrist-wearable device 500 is an instance of wrist-wearable device 108 described in reference to FIGS. 1A-1I herein, such that the wrist-wearable devices should be understood to have the features of the wrist-wearable device 500 and vice versa. FIG. 5A illustrates components of the wrist-wearable device 500, which can be used individually or in combination, including combinations that include other electronic devices and/or electronic components.

FIG. 5A shows a wearable band 510 and a watch body 520 (or capsule) being coupled, as discussed below, to form the wrist-wearable device 500. The wrist-wearable device 500 can perform various functions and/or operations associated with navigating through user interfaces and selectively opening applications, as well as the functions and/or operations described above with reference to FIGS. 1A-3.

As will be described in more detail below, operations executed by the wrist-wearable device 500 can include (i) presenting content to a user (e.g., displaying visual content via a display 505); (ii) detecting (e.g., sensing) user input (e.g., sensing a touch on peripheral button 523 and/or at a touch screen of the display 505, a hand gesture detected by sensors (e.g., biopotential sensors)); (iii) sensing biometric data via one or more sensors 513 (e.g., neuromuscular signals, heart rate, temperature, sleep, etc.); messaging (e.g., text, speech, video, etc.); image capture via one or more imaging devices or cameras 525; wireless communications (e.g., cellular, near field, Wi-Fi, personal area network, etc.); location determination; financial transactions; providing haptic feedback; alarms; notifications; biometric authentication; health monitoring; sleep monitoring.

The above-example functions can be executed independently in the watch body 520, independently in the wearable band 510, and/or via an electronic communication between the watch body 520 and the wearable band 510. In some embodiments, functions can be executed on the wrist-wearable device 500 while an AR environment is being presented (e.g., via one of the AR systems 400a to 400d). As the skilled artisan will appreciate upon reading the descriptions provided herein, the novel wearable devices described herein can be used with other types of AR environments.

The wearable band 510 can be configured to be worn by a user such that an inner (or inside) surface of the wearable structure 511 of the wearable band 510 is in contact with the user's skin. When worn by a user, sensors 513 contact the user's skin. The sensors 513 can sense biometric data such as a user's heart rate, saturated oxygen level, temperature, sweat level, neuromuscular signal sensors, or a combination thereof. The sensors 513 can also sense data about a user's environment, including a user's motion, altitude, location, orientation, gait, acceleration, position, or a combination thereof. In some embodiments, the sensors 513 are configured to track a position and/or motion of the wearable band 510. The one or more sensors 513 can include any of the sensors defined above and/or discussed below with respect to FIG. 5B.

The one or more sensors 513 can be distributed on an inside and/or an outside surface of the wearable band 510. In some embodiments, the one or more sensors 513 are uniformly spaced along the wearable band 510. Alternatively, in some embodiments, the one or more sensors 513 are positioned at distinct points along the wearable band 510. As shown in FIG. 5A, the one or more sensors 513 can be the same or distinct. For example, in some embodiments, the one or more sensors 513 can be shaped as a pill (e.g., sensor 513a), an oval, a circle a square, an oblong (e.g., sensor 513c) and/or any other shape that maintains contact with the user's skin (e.g., such that neuromuscular signal and/or other biometric data can be accurately measured at the user's skin). In some embodiments, the one or more sensors 513 are aligned to form pairs of sensors (e.g., for sensing neuromuscular signals based on differential sensing within each respective sensor). For example, sensor 513b is aligned with an adjacent sensor to form sensor pair 514a and sensor 513d is aligned with an adjacent sensor to form sensor pair 514b. In some embodiments, the wearable band 510 does not have a sensor pair. Alternatively, in some embodiments, the wearable band 510 has a predetermined number of sensor pairs (one pair of sensors, three pairs of sensors, four pairs of sensors, six pairs of sensors, sixteen pairs of sensors, etc.).

The wearable band 510 can include any suitable number of sensors 513. In some embodiments, the number and arrangements of sensors 513 depend on the particular application for which the wearable band 510 is used. For instance, a wearable band 510 configured as an armband, wristband, or chest-band may include a plurality of sensors 513 with different number of sensors 513 and different arrangement for each use case, such as medical use cases, compared to gaming or general day-to-day use cases.

In accordance with some embodiments, the wearable band 510 further includes an electrical ground electrode and a shielding electrode. The electrical ground and shielding electrodes, like the sensors 513, can be distributed on the inside surface of the wearable band 510 such that they contact a portion of the user's skin. For example, the electrical ground and shielding electrodes can be at an inside surface of coupling mechanism 516 or an inside surface of a wearable structure 511. The electrical ground and shielding electrodes can be formed and/or use the same components as the sensors 513. In some embodiments, the wearable band 510 includes more than one electrical ground electrode and more than one shielding electrode.

The sensors 513 can be formed as part of the wearable structure 511 of the wearable band 510. In some embodiments, the sensors 513 are flush or substantially flush with the wearable structure 511 such that they do not extend beyond the surface of the wearable structure 511. While flush with the wearable structure 511, the sensors 513 are still configured to contact the user's skin (e.g., via a skin-contacting surface). Alternatively, in some embodiments, the sensors 513 extend beyond the wearable structure 511 a predetermined distance (e.g., 0.1 mm to 2 mm) to make contact and depress into the user's skin. In some embodiments, the sensors 513 are coupled to an actuator (not shown) configured to adjust an extension height (e.g., a distance from the surface of the wearable structure 511) of the sensors 513 such that the sensors 513 make contact and depress into the user's skin. In some embodiments, the actuators adjust the extension height between 0.01 mm to 1.2 mm. This allows the user to customize the positioning of the sensors 513 to improve the overall comfort of the wearable band 510 when worn while still allowing the sensors 513 to contact the user's skin. In some embodiments, the sensors 513 are indistinguishable from the wearable structure 511 when worn by the user.

The wearable structure 511 can be formed of an elastic material, elastomers, etc., configured to be stretched and fitted to be worn by the user. In some embodiments, the wearable structure 511 is a textile or woven fabric. As described above, the sensors 513 can be formed as part of a wearable structure 511. For example, the sensors 513 can be molded into the wearable structure 511 or be integrated into a woven fabric (e.g., the sensors 513 can be sewn into the fabric and mimic the pliability of fabric (e.g., the sensors 513 can be constructed from a series of woven strands of fabric)).

The wearable structure 511 can include flexible electronic connectors that interconnect the sensors 513, the electronic circuitry, and/or other electronic components (described below in reference to FIG. 5B) that are enclosed in the wearable band 510. In some embodiments, the flexible electronic connectors are configured to interconnect the sensors 513, the electronic circuitry, and/or other electronic components of the wearable band 510 with respective sensors and/or other electronic components of another electronic device (e.g., watch body 520). The flexible electronic connectors are configured to move with the wearable structure 511 such that the user adjustment to the wearable structure 511 (e.g., resizing, pulling, folding, etc.) does not stress or strain the electrical coupling of components of the wearable band 510.

As described above, the wearable band 510 is configured to be worn by a user. In particular, the wearable band 510 can be shaped or otherwise manipulated to be worn by a user. For example, the wearable band 510 can be shaped to have a substantially circular shape such that it can be configured to be worn on the user's lower arm or wrist. Alternatively, the wearable band 510 can be shaped to be worn on another body part of the user, such as the user's upper arm (e.g., around a bicep), forearm, chest, legs, etc. The wearable band 510 can include a retaining mechanism 512 (e.g., a buckle, a hook and loop fastener, etc.) for securing the wearable band 510 to the user's wrist or other body part. While the wearable band 510 is worn by the user, the sensors 513 sense data (referred to as sensor data) from the user's skin. In particular, the sensors 513 of the wearable band 510 obtain (e.g., sense and record) neuromuscular signals.

The sensed data (e.g., sensed neuromuscular signals) can be used to detect and/or determine the user's intention to perform certain motor actions. In particular, the sensors 513 sense and record neuromuscular signals from the user as the user performs muscular activations (e.g., movements, gestures, etc.). The detected and/or determined motor actions (e.g., phalange (or digits) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on the display 505 of the wrist-wearable device 500 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by the sensors 513 can be used to provide a user with an enhanced interaction with a physical object (e.g., devices communicatively coupled with the wearable band 510) and/or a virtual object in an artificial-reality application generated by an artificial-reality system (e.g., user interface objects presented on the display 505 or another computing device (e.g., a smartphone)).

In some embodiments, the wearable band 510 includes one or more haptic devices 546 (FIG. 5B; e.g., a vibratory haptic actuator) that are configured to provide haptic feedback (e.g., a cutaneous and/or kinesthetic sensation, etc.) to the user's skin. The sensors 513, and/or the haptic devices 546 can be configured to operate in conjunction with multiple applications including, without limitation, health monitoring, social media, games, and artificial reality (e.g., the applications associated with artificial reality).

The wearable band 510 can also include coupling mechanism 516 (e.g., a cradle or a shape of the coupling mechanism can correspond to shape of the watch body 520 of the wrist-wearable device 500) for detachably coupling a capsule (e.g., a computing unit) or watch body 520 (via a coupling surface of the watch body 520) to the wearable band 510. In particular, the coupling mechanism 516 can be configured to receive a coupling surface proximate to the bottom side of the watch body 520 (e.g., a side opposite to a front side of the watch body 520 where the display 505 is located), such that a user can push the watch body 520 downward into the coupling mechanism 516 to attach the watch body 520 to the coupling mechanism 516. In some embodiments, the coupling mechanism 516 can be configured to receive a top side of the watch body 520 (e.g., a side proximate to the front side of the watch body 520 where the display 505 is located) that is pushed upward into the cradle, as opposed to being pushed downward into the coupling mechanism 516. In some embodiments, the coupling mechanism 516 is an integrated component of the wearable band 510 such that the wearable band 510 and the coupling mechanism 516 are a single unitary structure. In some embodiments, the coupling mechanism 516 is a type of frame or shell that allows the watch body 520 coupling surface to be retained within or on the wearable band 510 coupling mechanism 516 (e.g., a cradle, a tracker band, a support base, a clasp, etc.).

The coupling mechanism 516 can allow for the watch body 520 to be detachably coupled to the wearable band 510 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 520 to the wearable band 510 and to decouple the watch body 520 from the wearable band 510. For example, a user can twist, slide, turn, push, pull, or rotate the watch body 520 relative to the wearable band 510, or a combination thereof, to attach the watch body 520 to the wearable band 510 and to detach the watch body 520 from the wearable band 510. Alternatively, as discussed below, in some embodiments, the watch body 520 can be decoupled from the wearable band 510 by actuation of the release mechanism 529.

The wearable band 510 can be coupled with a watch body 520 to increase the functionality of the wearable band 510 (e.g., converting the wearable band 510 into a wrist-wearable device 500, adding an additional computing unit and/or battery to increase computational resources and/or a battery life of the wearable band 510, adding additional sensors to improve sensed data, etc.). As described above, the wearable band 510 (and the coupling mechanism 516) is configured to operate independently (e.g., execute functions independently) from watch body 520. For example, the coupling mechanism 516 can include one or more sensors 513 that contact a user's skin when the wearable band 510 is worn by the user and provide sensor data for determining control commands.

A user can detach the watch body 520 (or capsule) from the wearable band 510 in order to reduce the encumbrance of the wrist-wearable device 500 to the user. For embodiments in which the watch body 520 is removable, the watch body 520 can be referred to as a removable structure, such that in these embodiments the wrist-wearable device 500 includes a wearable portion (e.g., the wearable band 510) and a removable structure (the watch body 520).

Turning to the watch body 520, the watch body 520 can have a substantially rectangular or circular shape. The watch body 520 is configured to be worn by the user on their wrist or on another body part. More specifically, the watch body 520 is sized to be easily carried by the user, attached on a portion of the user's clothing, and/or coupled to the wearable band 510 (forming the wrist-wearable device 500). As described above, the watch body 520 can have a shape corresponding to the coupling mechanism 516 of the wearable band 510. In some embodiments, the watch body 520 includes a single release mechanism 529 or multiple release mechanisms (e.g., two release mechanisms 529 positioned on opposing sides of the watch body 520, such as spring-loaded buttons) for decoupling the watch body 520 and the wearable band 510. The release mechanism 529 can include, without limitation, a button, a knob, a plunger, a handle, a lever, a fastener, a clasp, a dial, a latch, or a combination thereof.

A user can actuate the release mechanism 529 by pushing, turning, lifting, depressing, shifting, or performing other actions on the release mechanism 529. Actuation of the release mechanism 529 can release (e.g., decouple) the watch body 520 from the coupling mechanism 516 of the wearable band 510, allowing the user to use the watch body 520 independently from wearable band 510, and vice versa. For example, decoupling the watch body 520 from the wearable band 510 can allow the user to capture images using rear-facing camera 525B. Although the coupling mechanism 516 is shown positioned at a corner of watch body 520, the release mechanism 529 can be positioned anywhere on watch body 520 that is convenient for the user to actuate. In addition, in some embodiments, the wearable band 510 can also include a respective release mechanism for decoupling the watch body 520 from the coupling mechanism 516. In some embodiments, the release mechanism 529 is optional and the watch body 520 can be decoupled from the coupling mechanism 516 as described above (e.g., via twisting, rotating, etc.).

The watch body 520 can include one or more peripheral buttons 523 and 527 for performing various operations at the watch body 520. For example, the peripheral buttons 523 and 527 can be used to turn on or wake (e.g., transition from a sleep state to an active state) the display 505, unlock the watch body 520, increase or decrease a volume, increase or decrease brightness, interact with one or more applications, interact with one or more user interfaces, etc. Additionally, or alternatively, in some embodiments, the display 505 operates as a touch screen and allows the user to provide one or more inputs for interacting with the watch body 520.

In some embodiments, the watch body 520 includes one or more sensors 521. The sensors 521 of the watch body 520 can be the same or distinct from the sensors 513 of the wearable band 510. The sensors 521 of the watch body 520 can be distributed on an inside and/or an outside surface of the watch body 520. In some embodiments, the sensors 521 are configured to contact a user's skin when the watch body 520 is worn by the user. For example, the sensors 521 can be placed on the bottom side of the watch body 520 and the coupling mechanism 516 can be a cradle with an opening that allows the bottom side of the watch body 520 to directly contact the user's skin. Alternatively, in some embodiments, the watch body 520 does not include sensors that are configured to contact the user's skin (e.g., including sensors internal and/or external to the watch body 520 that configured to sense data of the watch body 520 and the watch body 520's surrounding environment). In some embodiments, the sensors 513 are configured to track a position and/or motion of the watch body 520.

The watch body 520 and the wearable band 510 can share data using a wired communication method (e.g., a Universal Asynchronous Receiver/Transmitter (UART), a USB transceiver, etc.) and/or a wireless communication method (e.g., near field communication, Bluetooth, etc.). For example, the watch body 520 and the wearable band 510 can share data sensed by the sensors 513 and 521, as well as application- and device-specific information (e.g., active and/or available applications), output devices (e.g., display, speakers, etc.), input devices (e.g., touch screen, microphone, imaging sensors, etc.).

In some embodiments, the watch body 520 can include, without limitation, a front-facing camera 525A and/or a rear-facing camera 525B, sensors 521 (e.g., a biometric sensor, an IMU sensor, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 563; FIG. 5B), a touch sensor, a sweat sensor, etc.). In some embodiments, the watch body 520 can include one or more haptic devices 576 (FIG. 5B; a vibratory haptic actuator) that is configured to provide haptic feedback (e.g., a cutaneous and/or kinesthetic sensation, etc.) to the user. The sensors 521 and/or the haptic device 576 can also be configured to operate in conjunction with multiple applications including, without limitation, health-monitoring applications, social media applications, game applications, and artificial-reality applications (e.g., the applications associated with artificial reality).

As described above, the watch body 520 and the wearable band 510, when coupled, can form the wrist-wearable device 500. When coupled, the watch body 520 and wearable band 510 operate as a single device to execute functions (operations, detections, communications, etc.) described herein. In some embodiments, each device is provided with particular instructions for performing the one or more operations of the wrist-wearable device 500. For example, in accordance with a determination that the watch body 520 does not include neuromuscular signal sensors, the wearable band 510 can include alternative instructions for performing associated instructions (e.g., providing sensed neuromuscular signal data to the watch body 520 via a different electronic device). Operations of the wrist-wearable device 500 can be performed by the watch body 520 alone or in conjunction with the wearable band 510 (e.g., via respective processors and/or hardware components) and vice versa. In some embodiments, operations of the wrist-wearable device 500, the watch body 520, and/or the wearable band 510 can be performed in conjunction with one or more processors and/or hardware components of another communicatively coupled device (e.g., the HIPD 700; FIGS. 7A-7B).

As described below with reference to the block diagram of FIG. 5B, the wearable band 510 and/or the watch body 520 can each include independent resources required to independently execute functions. For example, the wearable band 510 and/or the watch body 520 can each include a power source (e.g., a battery), a memory, data storage, a processor (e.g., a central processing unit (CPU)), communications, a light source, and/or input/output devices.

FIG. 5B shows block diagrams of a computing system 530 corresponding to the wearable band 510, and a computing system 560 corresponding to the watch body 520, according to some embodiments. A computing system of the wrist-wearable device 500 includes a combination of components of the wearable band computing system 530 and the watch body computing system 560, in accordance with some embodiments.

The watch body 520 and/or the wearable band 510 can include one or more components shown in watch body computing system 560. In some embodiments, a single integrated circuit includes all or a substantial portion of the components of the watch body computing system 560 are included in a single integrated circuit. Alternatively, in some embodiments, components of the watch body computing system 560 are included in a plurality of integrated circuits that are communicatively coupled. In some embodiments, the watch body computing system 560 is configured to couple (e.g., via a wired or wireless connection) with the wearable band computing system 530, which allows the computing systems to share components, distribute tasks, and/or perform other operations described herein (individually or as a single device).

The watch body computing system 560 can include one or more processors 579, a controller 577, a peripherals interface 561, a power system 595, and memory (e.g., a memory 580), each of which are defined above and described in more detail below.

The power system 595 can include a charger input 596, a power-management integrated circuit (PMIC) 597, and a battery 598, each are which are defined above. In some embodiments, a watch body 520 and a wearable band 510 can have respective charger inputs (e.g., charger input 596 and 557), respective batteries (e.g., battery 598 and 559), and can share power with each other (e.g., the watch body 520 can power and/or charge the wearable band 510, and vice versa). Although watch body 520 and/or the wearable band 510 can include respective charger inputs, a single charger input can charge both devices when coupled. The watch body 520 and the wearable band 510 can receive a charge using a variety of techniques. In some embodiments, the watch body 520 and the wearable band 510 can use a wired charging assembly (e.g., power cords) to receive the charge. Alternatively, or in addition, the watch body 520 and/or the wearable band 510 can be configured for wireless charging. For example, a portable charging device can be designed to mate with a portion of watch body 520 and/or wearable band 510 and wirelessly deliver usable power to a battery of watch body 520 and/or wearable band 510. The watch body 520 and the wearable band 510 can have independent power systems (e.g., power system 595 and 556) to enable each to operate independently. The watch body 520 and wearable band 510 can also share power (e.g., one can charge the other) via respective PMICs (e.g., PMICs 597 and 558) that can share power over power and ground conductors and/or over wireless charging antennas.

In some embodiments, the peripherals interface 561 can include one or more sensors 521, many of which listed below are defined above. The sensors 521 can include one or more coupling sensors 562 for detecting when the watch body 520 is coupled with another electronic device (e.g., a wearable band 510). The sensors 521 can include imaging sensors 563 (one or more of the cameras 525 and/or separate imaging sensors 563 (e.g., thermal-imaging sensors)). In some embodiments, the sensors 521 include one or more SpO2 sensors 564. In some embodiments, the sensors 521 include one or more biopotential-signal sensors (e.g., EMG sensors 565, which may be disposed on a user-facing portion of the watch body 520 and/or the wearable band 510). In some embodiments, the sensors 521 include one or more capacitive sensors 566. In some embodiments, the sensors 521 include one or more heart rate sensors 567. In some embodiments, the sensors 521 include one or more IMUs 568. In some embodiments, one or more IMUs 568 can be configured to detect movement of a user's hand or other location that the watch body 520 is placed or held.

In some embodiments, the peripherals interface 561 includes an NFC component 569, a global-position system (GPS) component 570, a long-term evolution (LTE) component 571, and/or a Wi-Fi and/or Bluetooth communication component 572. In some embodiments, the peripherals interface 561 includes one or more buttons 573 (e.g., the peripheral buttons 523 and 527 in FIG. 5A), which, when selected by a user, cause operations to be performed at the watch body 520. In some embodiments, the peripherals interface 561 includes one or more indicators, such as a light emitting diode (LED), to provide a user with visual indicators (e.g., message received, low battery, an active microphone, and/or a camera, etc.).

The watch body 520 can include at least one display 505 for displaying visual representations of information or data to the user, including user-interface elements and/or three-dimensional (3D) virtual objects. The display can also include a touch screen for inputting user inputs, such as touch gestures, swipe gestures, and the like. The watch body 520 can include at least one speaker 574 and at least one microphone 575 for providing audio signals to the user and receiving audio input from the user. The user can provide user inputs through the microphone 575 and can also receive audio output from the speaker 574 as part of a haptic event provided by the haptic controller 578. The watch body 520 can include at least one camera 525, including a front-facing camera 525A and a rear-facing camera 525B. The cameras 525 can include ultra-wide-angle cameras, wide-angle cameras, fish-eye cameras, spherical cameras, telephoto cameras, a depth-sensing cameras, or other types of cameras.

The watch body computing system 560 can include one or more haptic controllers 578 and associated componentry (e.g., haptic devices 576) for providing haptic events at the watch body 520 (e.g., a vibrating sensation or audio output in response to an event at the watch body 520). The haptic controllers 578 can communicate with one or more haptic devices 576, such as electroacoustic devices, including a speaker of the one or more speakers 574 and/or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). The haptic controller 578 can provide haptic events to respective haptic actuators that are capable of being sensed by a user of the watch body 520. In some embodiments, the one or more haptic controllers 578 can receive input signals from an application of the applications 582.

In some embodiments, the computer system 530 and/or the computer system 560 can include memory 580, which can be controlled by a memory controller of the one or more controllers 577 and/or one or more processors 579. In some embodiments, software components stored in the memory 580 include one or more applications 582 configured to perform operations at the watch body 520. In some embodiments, the one or more applications 582 include games, word processors, messaging applications, calling applications, web browsers, social media applications, media streaming applications, financial applications, calendars, clocks, etc. In some embodiments, software components stored in the memory 580 include one or more communication interface modules 583 as defined above. In some embodiments, software components stored in the memory 580 include one or more graphics modules 584 for rendering, encoding, and/or decoding audio and/or visual data; and one or more data management modules 585 for collecting, organizing, and/or providing access to the data 587 stored in memory 580. In some embodiments, software components stored in the memory 580 include a notification module 586A, which is configured to perform the features described above in reference to FIGS. 1A-3. In some embodiments, one or more of applications 582 and/or one or more modules can work in conjunction with one another to perform various tasks at the watch body 520.

In some embodiments, software components stored in the memory 580 can include one or more operating systems 581 (e.g., a Linux-based operating system, an Android operating system, etc.). The memory 580 can also include data 587. The data 587 can include profile data 588A, sensor data 589A, media content data 590, application data 591, and notification data 592A, which stores data related to the performance of the features described above in reference to FIGS. 1A-3.

It should be appreciated that the watch body computing system 560 is an example of a computing system within the watch body 520, and that the watch body 520 can have more or fewer components than shown in the watch body computing system 560, combine two or more components, and/or have a different configuration and/or arrangement of the components. The various components shown in watch body computing system 560 are implemented in hardware, software, firmware, or a combination thereof, including one or more signal processing and/or application-specific integrated circuits.

Turning to the wearable band computing system 530, one or more components that can be included in the wearable band 510 are shown. The wearable band computing system 530 can include more or fewer components than shown in the watch body computing system 560, combine two or more components, and/or have a different configuration and/or arrangement of some or all of the components. In some embodiments, all, or a substantial portion of the components of the wearable band computing system 530 are included in a single integrated circuit. Alternatively, in some embodiments, components of the wearable band computing system 530 are included in a plurality of integrated circuits that are communicatively coupled. As described above, in some embodiments, the wearable band computing system 530 is configured to couple (e.g., via a wired or wireless connection) with the watch body computing system 560, which allows the computing systems to share components, distribute tasks, and/or perform other operations described herein (individually or as a single device).

The wearable band computing system 530, similar to the watch body computing system 560, can include one or more processors 549, one or more controllers 547 (including one or more haptics controller 548), a peripherals interface 531 that can include one or more sensors 513 and other peripheral devices, power source (e.g., a power system 556), and memory (e.g., a memory 550) that includes an operating system (e.g., an operating system 551), data (e.g., data 554 including profile data 588B, sensor data 589B, notification data, etc.), and one or more modules (e.g., a communications interface module 552, a data management module 553, a notification module 586B, etc.).

The one or more sensors 513 can be analogous to sensors 521 of the computer system 560 in light of the definitions above. For example, sensors 513 can include one or more coupling sensors 532, one or more SpO2 sensors 534, one or more EMG sensors 535, one or more capacitive sensors 536, one or more heart rate sensors 537, and one or more IMU sensors 538.

The peripherals interface 531 can also include other components analogous to those included in the peripheral interface 561 of the computer system 560, including an NFC component 539, a GPS component 540, an LTE component 541, a Wi-Fi and/or Bluetooth communication component 542, and/or one or more haptic devices 576 as described above in reference to peripherals interface 561. In some embodiments, the peripherals interface 531 includes one or more buttons 543, a display 533, a speaker 544, a microphone 545, and a camera 555. In some embodiments, the peripherals interface 531 includes one or more indicators, such as an LED.

It should be appreciated that the wearable band computing system 530 is an example of a computing system within the wearable band 510, and that the wearable band 510 can have more or fewer components than shown in the wearable band computing system 530, combine two or more components, and/or have a different configuration and/or arrangement of the components. The various components shown in wearable band computing system 530 can be implemented in one or a combination of hardware, software, and firmware, including one or more signal processing and/or application-specific integrated circuits.

The wrist-wearable device 500 with respect to FIG. 5A is an example of the wearable band 510 and the watch body 520 coupled, so the wrist-wearable device 500 will be understood to include the components shown and described for the wearable band computing system 530 and the watch body computing system 560. In some embodiments, wrist-wearable device 500 has a split architecture (e.g., a split mechanical architecture or a split electrical architecture) between the watch body 520 and the wearable band 510. In other words, all of the components shown in the wearable band computing system 530 and the watch body computing system 560 can be housed or otherwise disposed in a combined watch device 500, or within individual components of the watch body 520, wearable band 510, and/or portions thereof (e.g., a coupling mechanism 516 of the wearable band 510).

The techniques described above can be used with any device for sensing neuromuscular signals, including the arm-wearable devices of FIG. 5A-5B, but could also be used with other types of wearable devices for sensing neuromuscular signals (such as body-wearable or head-wearable devices that might have neuromuscular sensors closer to the brain or spinal column).

In some embodiments, a wrist-wearable device 500 can be used in conjunction with a head-wearable device described below (e.g., AR device 600 and VR device 610) and/or an HIPD 700, and the wrist-wearable device 500 can also be configured to be used to allow a user to control aspect of the artificial reality (e.g., by using EMG-based gestures to control user interface objects in the artificial reality and/or by allowing a user to interact with the touchscreen on the wrist-wearable device to also control aspects of the artificial reality). In some embodiments, a wrist-wearable device 500 can also be used in conjunction with a wearable garment, such as smart textile-based garment 800 described below in reference to FIGS. 8A-8C. Having thus described example wrist-wearable device, attention will now be turned to example head-wearable devices, such AR device 600 and VR device 610.

### Example Head-Wearable Devices

FIGS. 6A, 6B-1, 6B-2, and 6C show example head-wearable devices, in accordance with some embodiments. Head-wearable devices can include, but are not limited to, AR devices 610 (e.g., AR or smart eyewear devices, such as smart glasses, smart monocles, smart contacts, etc.), VR devices 610 (e.g., VR headsets, head-mounted displays (HMD)s, etc.), or other ocularly coupled devices. The AR devices 600 and the VR devices 610 are instances of the head-wearable devices 102 described in reference to FIGS. 1A-3 herein, such that the head-wearable device should be understood to have the features of the AR devices 600 and/or the VR devices 610, and vice versa. The AR devices 600 and the VR devices 610 can perform various functions and/or operations associated with navigating through user interfaces and selectively opening applications, as well as the functions and/or operations described above with reference to FIGS. 1A-3.

In some embodiments, an AR system (e.g., AR systems 400a-400d; FIGS. 4A-4D-2) includes an AR device 600 (as shown in FIG. 6A) and/or VR device 610 (as shown in FIGS. 6B-1-B-2). In some embodiments, the AR device 600 and the VR device 610 can include one or more analogous components (e.g., components for presenting interactive artificial-reality environments, such as processors, memory, and/or presentation devices, including one or more displays and/or one or more waveguides), some of which are described in more detail with respect to FIG. 6C. The head-wearable devices can use display projectors (e.g., display projector assemblies 607A and 607B) and/or waveguides for projecting representations of data to a user. Some embodiments of head-wearable devices do not include displays.

FIG. 6A shows an example visual depiction of the AR device 600 (e.g., which may also be described herein as augmented-reality glasses and/or smart glasses). The AR device 600 can work in conjunction with additional electronic components that are not shown in FIGS. 6A, such as a wearable accessory device and/or an intermediary processing device, in electronic communication or otherwise configured to be used in conjunction with the AR device 600. In some embodiments, the wearable accessory device and/or the intermediary processing device may be configured to couple with the AR device 600 via a coupling mechanism in electronic communication with a coupling sensor 624, where the coupling sensor 624 can detect when an electronic device becomes physically or electronically coupled with the AR device 600. In some embodiments, the AR device 600 can be configured to couple to a housing (e.g., a portion of frame 604 or temple arms 605), which may include one or more additional coupling mechanisms configured to couple with additional accessory devices. The components shown in FIG. 6A can be implemented in hardware, software, firmware, or a combination thereof, including one or more signal-processing components and/or application-specific integrated circuits (ASICs).

The AR device 600 includes mechanical glasses components, including a frame 604 configured to hold one or more lenses (e.g., one or both lenses 606-1 and 606-2). One of ordinary skill in the art will appreciate that the AR device 600 can include additional mechanical components, such as hinges configured to allow portions of the frame 604 of the AR device 600 to be folded and unfolded, a bridge configured to span the gap between the lenses 606-1 and 606-2 and rest on the user's nose, nose pads configured to rest on the bridge of the nose and provide support for the AR device 600, earpieces configured to rest on the user's ears and provide additional support for the AR device 600, temple arms 605 configured to extend from the hinges to the earpieces of the AR device 600, and the like. One of ordinary skill in the art will further appreciate that some examples of the AR device 600 can include none of the mechanical components described herein. For example, smart contact lenses configured to present artificial-reality to users may not include any components of the AR device 600.

The lenses 606-1 and 606-2 can be individual displays or display devices (e.g., a waveguide for projected representations). The lenses 606-1 and 606-2 may act together or independently to present an image or series of images to a user. In some embodiments, the lenses 606-1 and 606-2 can operate in conjunction with one or more display projector assemblies 607A and 607B to present image data to a user. While the AR device 600 includes two displays, embodiments of this disclosure may be implemented in AR devices with a single near-eye display (NED) or more than two NEDs.

The AR device 600 includes electronic components, many of which will be described in more detail below with respect to FIG. 6C. Some example electronic components are illustrated in FIG. 6A, including sensors 623-1, 623-2, 623-3, 623-4, 623-5, and 623-6, which can be distributed along a substantial portion of the frame 604 of the AR device 600. The different types of sensors are described below in reference to FIG. 6C. The AR device 600 also includes a left camera 639A and a right camera 639B, which are located on different sides of the frame 604. And the eyewear device includes one or more processors 648A and 648B (e.g., an integral microprocessor, such as an ASIC) that is embedded into a portion of the frame 604.

FIGS. 6B-1 and 6B-2 show an example visual depiction of the VR device 610 (e.g., a head-mounted display (HMD) 612, also referred to herein as an artificial-reality headset, a head-wearable device, a VR headset, etc.). The HMD 612 includes a front body 614 and a frame 616 (e.g., a strap or band) shaped to fit around a user's head. In some embodiments, the front body 614 and/or the frame 616 includes one or more electronic elements for facilitating presentation of and/or interactions with an AR and/or VR system (e.g., displays, processors (e.g., processor 648A-1), IMUs, tracking emitter or detectors, sensors, etc.). In some embodiments, the HMD 612 includes output audio transducers (e.g., an audio transducer 618-1), as shown in FIG. 6B-2. In some embodiments, one or more components, such as the output audio transducer(s) 618-1 and the frame 616, can be configured to attach and detach (e.g., are detachably attachable) to the HMD 612 (e.g., a portion or all of the frame 616, and/or the output audio transducer 618-1), as shown in FIG. 6B-2. In some embodiments, coupling a detachable component to the HMD 612 causes the detachable component to come into electronic communication with the HMD 612. The VR device 610 includes electronic components, many of which will be described in more detail below with respect to FIG. 6C.

FIG. 6B-1 to 6B-2 also show that the VR device 610 one or more cameras, such as the left camera 639A and the right camera 639B, which can be analogous to the left and right cameras on the frame 604 of the AR device 600. In some embodiments, the VR device 610 includes one or more additional cameras (e.g., cameras 639C and 639D), which can be configured to augment image data obtained by the cameras 639A and 639B by providing more information. For example, the camera 639C can be used to supply color information that is not discerned by cameras 639A and 639B. In some embodiments, one or more of the cameras 639A to 639D can include an optional IR cut filter configured to remove IR light from being received at the respective camera sensors.

The VR device 610 can include a housing 690 storing one or more components of the VR device 610 and/or additional components of the VR device 610. The housing 690 can be a modular electronic device configured to couple with the VR device 610 (or an AR device 600) and supplement and/or extend the capabilities of the VR device 610 (or an AR device 600). For example, the housing 690 can include additional sensors, cameras, power sources, processors (e.g., processor 648A-2), etc. to improve and/or increase the functionality of the VR device 610. Examples of the different components included in the housing 690 are described below in reference to FIG. 6C.

Alternatively or in addition, in some embodiments, the head-wearable device, such as the VR device 610 and/or the AR device 600), includes, or is communicatively coupled to, another external device (e.g., a paired device), such as an HIPD 7 (discussed below in reference to FIGS. 7A-7B) and/or an optional neckband. The optional neckband can couple to the head-wearable device via one or more connectors (e.g., wired or wireless connectors). The head-wearable device and the neckband can operate independently without any wired or wireless connection between them. In some embodiments, the components of the head-wearable device and the neckband are located on one or more additional peripheral devices paired with the head-wearable device, the neckband, or some combination thereof. Furthermore, the neckband is intended to represent any suitable type or form of paired device. Thus, the following discussion of neckband may also apply to various other paired devices, such as smart watches, smart phones, wrist bands, other wearable devices, hand-held controllers, tablet computers, or laptop computers.

In some situations, pairing external devices, such as an intermediary processing device (e.g., an HIPD device 700, an optional neckband, and/or wearable accessory device) with the head-wearable devices (e.g., an AR device 600 and/or VR device 610) enables the head-wearable devices to achieve a similar form factor of a pair of glasses while still providing sufficient battery and computation power for expanded capabilities. Some, or all, of the battery power, computational resources, and/or additional features of the head-wearable devices can be provided by a paired device or shared between a paired device and the head-wearable devices, thus reducing the weight, heat profile, and form factor of the head-wearable devices overall while allowing the head-wearable devices to retain its desired functionality. For example, the intermediary processing device (e.g., the HIPD 700) can allow components that would otherwise be included in a head-wearable device to be included in the intermediary processing device (and/or a wearable device or accessory device), thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on the head-wearable devices, standing alone. Because weight carried in the intermediary processing device can be less invasive to a user than weight carried in the head-wearable devices, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

In some embodiments, the intermediary processing device is communicatively coupled with the head-wearable device and/or to other devices. The other devices may provide certain functions (e.g., tracking, localizing, depth mapping, processing, storage, etc.) to the head-wearable device. In some embodiments, the intermediary processing device includes a controller and a power source. In some embodiments, sensors of the intermediary processing device are configured to sense additional data that can be shared with the head-wearable devices in an electronic format (analog or digital).

The controller of the intermediary processing device processes information generated by the sensors on the intermediary processing device and/or the head-wearable devices. The intermediary processing device, like an HIPD 700, can process information generated by one or more sensors of its sensors and/or information provided by other communicatively coupled devices. For example, a head-wearable device can include an IMU, and the intermediary processing device (neckband and/or an HIPD 700) can compute all inertial and spatial calculations from the IMUs located on the head-wearable device. Additional examples of processing performed by a communicatively coupled device, such as the HIPD 700, are provided below in reference to FIGS. 7A and 7B.

Artificial-reality systems may include a variety of types of visual feedback mechanisms. For example, display devices in the AR devices 600 and/or the VR devices 610 may include one or more liquid-crystal displays (LCDs), light emitting diode (LED) displays, organic LED (OLED) displays, and/or any other suitable type of display screen. Artificial-reality systems may include a single display screen for both eyes or may provide a display screen for each eye, which may allow for additional flexibility for varifocal adjustments or for correcting a refractive error associated with the user's vision. Some artificial-reality systems also include optical subsystems having one or more lenses (e.g., conventional concave or convex lenses, Fresnel lenses, or adjustable liquid lenses) through which a user may view a display screen. In addition to or instead of using display screens, some artificial-reality systems include one or more projection systems. For example, display devices in the AR device 600 and/or the VR device 610 may include micro-LED projectors that project light (e.g., using a waveguide) into display devices, such as clear combiner lenses that allow ambient light to pass through. The display devices may refract the projected light toward a user's pupil and may enable a user to simultaneously view both artificial-reality content and the real world. Artificial-reality systems may also be configured with any other suitable type or form of image projection system. As noted, some AR systems may, instead of blending an artificial reality with actual reality, substantially replace one or more of a user's sensory perceptions of the real world with a virtual experience.

While the example head-wearable devices are respectively described herein as the AR device 600 and the VR device 610, either or both of the example head-wearable devices described herein can be configured to present fully-immersive VR scenes presented in substantially all of a user's field of view, additionally or alternatively to, subtler augmented-reality scenes that are presented within a portion, less than all, of the user's field of view.

In some embodiments, the AR device 600 and/or the VR device 610 can include haptic feedback systems. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback can be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices (e.g., wrist-wearable devices which may be incorporated into headwear, gloves, body suits, handheld controllers, environmental devices (e.g., chairs or floormats), and/or any other type of device or system, such as a wrist-wearable device 500, an HIPD 700, smart textile-based garment 800, etc.), and/or other devices described herein.

FIG. 6C illustrates a computing system 620 and an optional housing 690, each of which show components that can be included in a head-wearable device (e.g., the AR device 600 and/or the VR device 610). In some embodiments, more or less components can be included in the optional housing 690 depending on practical restraints of the respective head-wearable device being described. Additionally or alternatively, the optional housing 690 can include additional components to expand and/or augment the functionality of a head-wearable device.

In some embodiments, the computing system 620 and/or the optional housing 690 can include one or more peripheral interfaces 622A and 622B, one or more power systems 642A and 642B (including charger input 643, PMIC 644, and battery 645), one or more controllers 646A 646B (including one or more haptic controllers 647), one or more processors 648A and 648B (as defined above, including any of the examples provided), and memory 650A and 650B, which can all be in electronic communication with each other. For example, the one or more processors 648A and/or 648B can be configured to execute instructions stored in the memory 650A and/or 650B, which can cause a controller of the one or more controllers 646A and/or 646B to cause operations to be performed at one or more peripheral devices of the peripherals interfaces 622A and/or 622B. In some embodiments, each operation described can occur based on electrical power provided by the power system 642A and/or 642B.

In some embodiments, the peripherals interface 622A can include one or more devices configured to be part of the computing system 620, many of which have been defined above and/or described with respect to wrist-wearable devices shown in FIGS. 5A and 5B. For example, the peripherals interface can include one or more sensors 623A. Some example sensors include: one or more coupling sensors 624, one or more acoustic sensors 625, one or more imaging sensors 626, one or more EMG sensors 627, one or more capacitive sensors 628, and/or one or more IMUs 629. In some embodiments, the sensors 623A further include depth sensors 667, light sensors 668 and/or any other types of sensors defined above or described with respect to any other embodiments discussed herein.

In some embodiments, the peripherals interface can include one or more additional peripheral devices, including one or more NFC devices 630, one or more GPS devices 631, one or more LTE devices 632, one or more WiFi and/or Bluetooth devices 633, one or more buttons 634 (e.g., including buttons that are slidable or otherwise adjustable), one or more displays 635A, one or more speakers 636A, one or more microphones 637A, one or more cameras 638A (e.g., including the a first camera 639-1 through nth camera 639-n, which are analogous to the left camera 639A and/or the right camera 639B), one or more haptic devices 640; and/or any other types of peripheral devices defined above or described with respect to any other embodiments discussed herein.

The head-wearable devices can include a variety of types of visual feedback mechanisms (e.g., presentation devices). For example, display devices in the AR device 600 and/or the VR device 610 can include one or more liquid-crystal displays (LCDs), light emitting diode (LED) displays, organic LED (OLED) displays, micro-LEDs, and/or any other suitable types of display screens. The head-wearable devices can include a single display screen (e.g., configured to be seen by both eyes), and/or can provide separate display screens for each eye, which can allow for additional flexibility for varifocal adjustments and/or for correcting a refractive error associated with the user's vision. Some embodiments of the head-wearable devices also include optical subsystems having one or more lenses (e.g., conventional concave or convex lenses, Fresnel lenses, or adjustable liquid lenses) through which a user can view a display screen. For example, respective displays 635A can be coupled to each of the lenses 606-1 and 606-2 of the AR device 600. The displays 635A coupled to each of the lenses 606-1 and 606-2 can act together or independently to present an image or series of images to a user. In some embodiments, the AR device 600 and/or the VR device 610 includes a single display 635A (e.g., a near-eye display) or more than two displays 635A.

In some embodiments, a first set of one or more displays 635A can be used to present an augmented-reality environment, and a second set of one or more display devices 635A can be used to present a virtual-reality environment. In some embodiments, one or more waveguides are used in conjunction with presenting artificial-reality content to the user of the AR device 600 and/or the VR device 610 (e.g., as a means of delivering light from a display projector assembly and/or one or more displays 635A to the user's eyes). In some embodiments, one or more waveguides are fully or partially integrated into the AR device 600 and/or the VR device 610. Additionally, or alternatively to display screens, some artificial-reality systems include one or more projection systems. For example, display devices in the AR device 600 and/or the VR device 610 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. The head-wearable devices can also be configured with any other suitable type or form of image projection system. In some embodiments, one or more waveguides are provided additionally or alternatively to the one or more display(s) 635A.

In some embodiments of the head-wearable devices, ambient light and/or a real-world live view (e.g., a live feed of the surrounding environment that a user would normally see) can be passed through a display element of a respective head-wearable device presenting aspects of the AR system. In some embodiments, ambient light and/or the real-world live view can be passed through a portion less than all, of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable devices, and an amount of ambient light and/or the real-world live view (e.g., 15-50% of the ambient light and/or the real-world live view) can be passed through the user interface element, such that the user can distinguish at least a portion of the physical environment over which the user interface element is being displayed.

The head-wearable devices can include one or more external displays 635A for presenting information to users. For example, an external display 635A can be used to show a current battery level, network activity (e.g., connected, disconnected, etc.), current activity (e.g., playing a game, in a call, in a meeting, watching a movie, etc.), and/or other relevant information. In some embodiments, the external displays 635A can be used to communicate with others. For example, a user of the head-wearable device can cause the external displays 635A to present a do not disturb notification. The external displays 635A can also be used by the user to share any information captured by the one or more components of the peripherals interface 622A and/or generated by head-wearable device (e.g., during operation and/or performance of one or more applications).

The memory 650A can include instructions and/or data executable by one or more processors 648A (and/or processors 648B of the housing 690) and/or a memory controller of the one or more controllers 646A (and/or controller 646B of the housing 690). The memory 650A can include one or more operating systems 651; one or more applications 652; one or more communication interface modules 653A; one or more graphics modules 654A; one or more AR processing modules 655A; notification module 656 for providing notifications to a wearer of the head-wearable device and or peripheral devices of the system; and/or any other types of modules or components defined above or described with respect to any other embodiments discussed herein.

The data 660 stored in memory 650A can be used in conjunction with one or more of the applications and/or programs discussed above. The data 660 can include profile data 661; sensor data 662; media content data 663; AR application data 664; notification data 665 for notifications received at the various sources of the system; and/or any other types of data defined above or described with respect to any other embodiments discussed herein.

In some embodiments, the controller 646A of the head-wearable devices processes information generated by the sensors 623A on the head-wearable devices and/or another component of the head-wearable devices and/or communicatively coupled with the head-wearable devices (e.g., components of the housing 690, such as components of peripherals interface 622B). For example, the controller 646A can process information from the acoustic sensors 625 and/or image sensors 626. For each detected sound, the controller 646A can perform a direction of arrival (DOA) estimation to estimate a direction from which the detected sound arrived at a head-wearable device. As one or more of the acoustic sensors 625 detects sounds, the controller 646A can populate an audio data set with the information (e.g., represented by sensor data 662).

In some embodiments, a physical electronic connector can convey information between the head-wearable devices and another electronic device, and/or between one or more processors 648A of the head-wearable devices and the controller 646A. The information can be in the form of optical data, electrical data, wireless data, or any other transmittable data form. Moving the processing of information generated by the head-wearable devices to an intermediary processing device can reduce weight and heat in the eyewear device, making it more comfortable and safer for a user. In some embodiments, an optional accessory device (e.g., an electronic neckband or an HIPD 700) is coupled to the head-wearable devices via one or more connectors. The connectors can be wired or wireless connectors and can include electrical and/or non-electrical (e.g., structural) components. In some embodiments, the head-wearable devices and the accessory device can operate independently without any wired or wireless connection between them.

The head-wearable devices can include various types of computer vision components and subsystems. For example, the AR device 600 and/or the VR device 610 can include one or more optical sensors such as two-dimensional (2D) or three-dimensional (3D) cameras, time-of-flight depth sensors, single-beam or sweeping laser rangefinders, 3D LiDAR sensors, and/or any other suitable type or form of optical sensor. A head-wearable device can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate interactable virtual objects (which can be replicas or digital twins of real-world objects that can be interacted with in AR environment), among a variety of other functions. For example, FIGS. 6B-1 and 6B-2 show the VR device 610 having cameras 639A-639D, which can be used to provide depth information for creating a voxel field and a two-dimensional mesh to provide object information to the user to avoid collisions.

The optional housing 690 can include analogous components to those describe above with respect to the computing system 620. For example, the optional housing 690 can include a respective peripherals interface 622B including more or less components to those described above with respect to the peripherals interface 622A. As described above, the components of the optional housing 690 can be used augment and/or expand on the functionality of the head-wearable devices. For example, the optional housing 690 can include respective sensors 623B, speakers 636B, displays 635B, microphones 637B, cameras 638B, and/or other components to capture and/or present data. Similarly, the optional housing 690 can include one or more processors 648B, controllers 646B, and/or memory 650B (including respective communication interface modules 653B; one or more graphics modules 654B; one or more AR processing modules 655B, etc.) that can be used individually and/or in conjunction with the components of the computing system 620.

The techniques described above in FIGS. 6A-6C can be used with different head-wearable devices. In some embodiments, the head-wearable devices (e.g., the AR device 600 and/or the VR device 610) can be used in conjunction with one or more wearable device such as a wrist-wearable device 500 (or components thereof) and/or a smart textile-based garment 800 (FIGS. 8A-8C), as well as an HIPD 700. Having thus described example the head-wearable devices, attention will now be turned to example handheld intermediary processing devices, such as HIPD 700.

### Example Handheld Intermediary Processing Devices

FIGS. 7A and 7B illustrate an example handheld intermediary processing device (HIPD) 700, in accordance with some embodiments. The HIPD 700 can perform various functions and/or operations associated with navigating through user interfaces and selectively opening applications, as well as the functions and/or operations described above with reference to FIGS. 1A-3.

FIG. 7A shows a top view 705 and a side view 725 of the HIPD 700. The HIPD 700 is configured to communicatively couple with one or more wearable devices (or other electronic devices) associated with a user. For example, the HIPD 700 is configured to communicatively couple with a user's wrist-wearable device 500 (or components thereof, such as the watch body 520 and the wearable band 510), AR device 600, and/or VR device 610. The HIPD 700 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which the HIPD 700 can successfully be communicatively coupled with an electronic device, such as a wearable device).

The HIPD 700 can perform various functions independently and/or in conjunction with one or more wearable devices (e.g., wrist-wearable device 500, AR device 600, VR device 610, etc.). The HIPD 700 is configured to increase and/or improve the functionality of communicatively coupled devices, such as the wearable devices. The HIPD 700 is configured to perform one or more functions or operations associated with interacting with user interfaces and applications of communicatively coupled devices, interacting with an AR environment, interacting with VR environment, and/or operating as a human-machine interface controller. Additionally, as will be described in more detail below, functionality and/or operations of the HIPD 700 can include, without limitation, task offloading and/or handoffs; thermals offloading and/or handoffs; 6 degrees of freedom (6DoF) raycasting and/or gaming (e.g., using imaging devices or cameras 714A and 714B, which can be used for simultaneous localization and mapping (SLAM) and/or with other image processing techniques); portable charging; messaging; image capturing via one or more imaging devices or cameras (e.g., cameras 722A and 722B); sensing user input (e.g., sensing a touch on a multi-touch input surface 702); wireless communications and/or interlining (e.g., cellular, near field, Wi-Fi, personal area network, etc.); location determination; financial transactions; providing haptic feedback; alarms; notifications; biometric authentication; health monitoring; sleep monitoring; etc. The above-example functions can be executed independently in the HIPD 700 and/or in communication between the HIPD 700 and another wearable device described herein. In some embodiments, functions can be executed on the HIPD 700 in conjunction with an AR environment. As the skilled artisan will appreciate upon reading the descriptions provided herein, the novel the HIPD 700 described herein can be used with any type of suitable AR environment.

While the HIPD 700 is communicatively coupled with a wearable device and/or other electronic device, the HIPD 700 is configured to perform one or more operations initiated at the wearable device and/or the other electronic device. In particular, one or more operations of the wearable device and/or the other electronic device can be offloaded to the HIPD 700 to be performed. The HIPD 700 performs the one or more operations of the wearable device and/or the other electronic device and provides to data corresponded to the completed operations to the wearable device and/or the other electronic device. For example, a user can initiate a video stream using AR device 600 and back-end tasks associated with performing the video stream (e.g., video rendering) can be offloaded to the HIPD 700, which the HIPD 700 performs and provides corresponding data to the AR device 600 to perform remaining front-end tasks associated with the video stream (e.g., presenting the rendered video data via a display of the AR device 600). In this way, the HIPD 700, which has more computational resources and greater thermal headroom than a wearable device, can perform computationally intensive tasks for the wearable device improving performance of an operation performed by the wearable device.

The HIPD 700 includes a multi-touch input surface 702 on a first side (e.g., a front surface) that is configured to detect one or more user inputs. In particular, the multi-touch input surface 702 can detect single tap inputs, multi-tap inputs, swipe gestures and/or inputs, force-based and/or pressure-based touch inputs, held taps, and the like. The multi-touch input surface 702 is configured to detect capacitive touch inputs and/or force (and/or pressure) touch inputs. The multi-touch input surface 702 includes a first touch-input surface 704 defined by a surface depression, and a second touch-input surface 706 defined by a substantially planar portion. The first touch-input surface 704 can be disposed adjacent to the second touch-input surface 706. In some embodiments, the first touch-input surface 704 and the second touch-input surface 706 can be different dimensions, shapes, and/or cover different portions of the multi-touch input surface 702. For example, the first touch-input surface 704 can be substantially circular and the second touch-input surface 706 is substantially rectangular. In some embodiments, the surface depression of the multi-touch input surface 702 is configured to guide user handling of the HIPD 700. In particular, the surface depression is configured such that the user holds the HIPD 700 upright when held in a single hand (e.g., such that the using imaging devices or cameras 714A and 714B are pointed toward a ceiling or the sky). Additionally, the surface depression is configured such that the user's thumb rests within the first touch-input surface 704.

In some embodiments, the different touch-input surfaces include a plurality of touch-input zones. For example, the second touch-input surface 706 includes at least a first touch-input zone 708 within a second touch-input zone 706 and a third touch-input zone 710 within the first touch-input zone 708. In some embodiments, one or more of the touch-input zones are optional and/or user defined (e.g., a user can specific a touch-input zone based on their preferences). In some embodiments, each touch-input surface and/or touch-input zone is associated with a predetermined set of commands. For example, a user input detected within the first touch-input zone 708 causes the HIPD 700 to perform a first command and a user input detected within the second touch-input zone 706 causes the HIPD 700 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, the first touch-input zone 708 can be configured to detect force touch inputs (e.g., a magnitude at which the user presses down) and capacitive touch inputs, and the second touch-input zone 706 can be configured to detect capacitive touch inputs.

The HIPD 700 includes one or more sensors 751 for sensing data used in the performance of one or more operations and/or functions. For example, the HIPD 700 can include an IMU that is used in conjunction with cameras 714 for 3-dimensional object manipulation (e.g., enlarging, moving, destroying, etc. an object) in an AR or VR environment. Non-limiting examples of the sensors 751 included in the HIPD 700 include a light sensor, a magnetometer, a depth sensor, a pressure sensor, and a force sensor. Additional examples of the sensors 751 are provided below in reference to FIG. 7B.

The HIPD 700 can include one or more light indicators 712 to provide one or more notifications to the user. In some embodiments, the light indicators are LEDs or other types of illumination devices. The light indicators 712 can operate as a privacy light to notify the user and/or others near the user that an imaging device and/or microphone are active. In some embodiments, a light indicator is positioned adjacent to one or more touch-input surfaces. For example, a light indicator can be positioned around the first touch-input surface 704. The light indicators can be illuminated in different colors and/or patterns to provide the user with one or more notifications and/or information about the device. For example, a light indicator positioned around the first touch-input surface 704 can flash when the user receives a notification (e.g., a message), change red when the HIPD 700 is out of power, operate as a progress bar (e.g., a light ring that is closed when a task is completed (e.g., 0% to 100%)), operates as a volume indicator, etc.).

In some embodiments, the HIPD 700 includes one or more additional sensors on another surface. For example, as shown FIG. 7A, HIPD 700 includes a set of one or more sensors (e.g., sensor set 720) on an edge of the HIPD 700. The sensor set 720, when positioned on an edge of the of the HIPD 700, can be pe positioned at a predetermined tilt angle (e.g., 26 degrees), which allows the sensor set 720 to be angled toward the user when placed on a desk or other flat surface. Alternatively, in some embodiments, the sensor set 720 is positioned on a surface opposite the multi-touch input surface 702 (e.g., a back surface). The one or more sensors of the sensor set 720 are discussed in detail below.

The side view 725 of the of the HIPD 700 shows the sensor set 720 and camera 714B. The sensor set 720 includes one or more cameras 722A and 722B, a depth projector 724, an ambient light sensor 728, and a depth receiver 730. In some embodiments, the sensor set 720 includes a light indicator 726. The light indicator 726 can operate as a privacy indicator to let the user and/or those around them know that a camera and/or microphone is active. The sensor set 720 is configured to capture a user's facial expression such that the user can puppet a custom avatar (e.g., showing emotions, such as smiles, laughter, etc., on the avatar or a digital representation of the user). The sensor set 720 can be configured as a side stereo RGB system, a rear indirect Time-of-Flight (iToF) system, or a rear stereo RGB system. As the skilled artisan will appreciate upon reading the descriptions provided herein, the novel HIPD 700 described herein can use different sensor set 720 configurations and/or sensor set 720 placement.

In some embodiments, the HIPD 700 includes one or more haptic devices 771 (FIG. 7B; e.g., a vibratory haptic actuator) that are configured to provide haptic feedback (e.g., kinesthetic sensation). The sensors 751, and/or the haptic devices 771 can be configured to operate in conjunction with multiple applications and/or communicatively coupled devices including, without limitation, a wearable devices, health monitoring applications, social media applications, game applications, and artificial reality applications (e.g., the applications associated with artificial reality).

The HIPD 700 is configured to operate without a display. However, in optional embodiments, the HIPD 700 can include a display 768 (FIG. 7B). The HIPD 700 can also income one or more optional peripheral buttons 767 (FIG. 7B). For example, the peripheral buttons 767 can be used to turn on or turn off the HIPD 700. Further, the HIPD 700 housing can be formed of polymers and/or elastomer elastomers. The HIPD 700 can be configured to have a non-slip surface to allow the HIPD 700 to be placed on a surface without requiring a user to watch over the HIPD 700. In other words, the HIPD 700 is designed such that it would not easily slide off a surfaces. In some embodiments, the HIPD 700 include one or magnets to couple the HIPD 700 to another surface. This allows the user to mount the HIPD 700 to different surfaces and provide the user with greater flexibility in use of the HIPD 700.

As described above, the HIPD 700 can distribute and/or provide instructions for performing the one or more tasks at the HIPD 700 and/or a communicatively coupled device. For example, the HIPD 700 can identify one or more back-end tasks to be performed by the HIPD 700 and one or more front-end tasks to be performed by a communicatively coupled device. While the HIPD 700 is configured to offload and/or handoff tasks of a communicatively coupled device, the HIPD 700 can perform both back-end and front-end tasks (e.g., via one or more processors, such as CPU 777; FIG. 7B). The HIPD 700 can, without limitation, can be used to perform augmenting calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. The HIPD 700 can perform the above operations alone or in conjunction with a wearable device (or other communicatively coupled electronic device).

FIG. 7B shows block diagrams of a computing system 740 of the HIPD 700, in accordance with some embodiments. The HIPD 700, described in detail above, can include one or more components shown in HIPD computing system 740. The HIPD 700 will be understood to include the components shown and described below for the HIPD computing system 740. In some embodiments, all, or a substantial portion of the components of the HIPD computing system 740 are included in a single integrated circuit. Alternatively, in some embodiments, components of the HIPD computing system 740 are included in a plurality of integrated circuits that are communicatively coupled.

The HIPD computing system 740 can include a processor (e.g., a CPU 777, a GPU, and/or a CPU with integrated graphics), a controller 775, a peripherals interface 750 that includes one or more sensors 751 and other peripheral devices, a power source (e.g., a power system 795), and memory (e.g., a memory 778) that includes an operating system (e.g., an operating system 779), data (e.g., data 788), one or more applications (e.g., applications 780), and one or more modules (e.g., a communications interface module 781, a graphics module 782, a task and processing management module 783, an interoperability module 784, an AR processing module 785, a data management module 786, a notification module 787, etc.). The HIPD computing system 740 further includes a power system 795 that includes a charger input and output 796, a PMIC 797, and a battery 798, all of which are defined above.

In some embodiments, the peripherals interface 750 can include one or more sensors 751. The sensors 751 can include analogous sensors to those described above in reference to FIG. 5B. For example, the sensors 751 can include imaging sensors 754, (optional) EMG sensors 756, IMUs 758, and capacitive sensors 760. In some embodiments, the sensors 751 can include one or more pressure sensor 752 for sensing pressure data, an altimeter 753 for sensing an altitude of the HIPD 700, a magnetometer 755 for sensing a magnetic field, a depth sensor 757 (or a time-of flight sensor) for determining a difference between the camera and the subject of an image, a position sensor 759 (e.g., a flexible position sensor) for sensing a relative displacement or position change of a portion of the HIPD 700, a force sensor 761 for sensing a force applied to a portion of the HIPD 700, and a light sensor 762 (e.g., an ambient light sensor) for detecting an amount of lighting. The sensors 751 can include one or more sensors not shown in FIG. 7B.

Analogous to the peripherals described above in reference to FIGS. 5B, the peripherals interface 750 can also include an NFC component 763, a GPS component 764, an LTE component 765, a Wi-Fi and/or Bluetooth communication component 766, a speaker 769, a haptic device 771, and a microphone 773. As described above in reference to FIG. 7A, the HIPD 700 can optionally include a display 768 and/or one or more buttons 767. The peripherals interface 750 can further include one or more cameras 770, touch surfaces 772, and/or one or more light emitters 774. The multi-touch input surface 702 described above in reference to FIG. 7A is an example of touch surface 772. The light emitters 774 can be one or more LEDs, lasers, etc. and can be used to project or present information to a user. For example, the light emitters 774 can include light indicators 712 and 726 described above in reference to FIG. 7A. The cameras 770 (e.g., cameras 714A, 714B, and 722 described above in FIG. 7A) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other available cameras. Cameras 770 can be used for SLAM; 6 DoF ray casting, gaming, object manipulation, and/or other rendering; facial recognition and facial expression recognition, etc.

Similar to the watch body computing system 560 and the watch band computing system 530 described above in reference to FIG. 5B, the HIPD computing system 740 can include one or more haptic controllers 776 and associated componentry (e.g., haptic devices 771) for providing haptic events at the HIPD 700.

Memory 778 can include high-speed random-access memory and/or non-volatile memory, such as one or more magnetic disk storage devices, flash memory devices, or other non-volatile solid-state memory devices. Access to the memory 778 by other components of the HIPD 700, such as the one or more processors and the peripherals interface 750, can be controlled by a memory controller of the controllers 775.

In some embodiments, software components stored in the memory 778 include one or more operating systems 779, one or more applications 780, one or more communication interface modules 781, one or more graphics modules 782, one or more data management modules 785, which are analogous to the software components described above in reference to FIG. 5B. The software components stored in the memory 778 can also include a notification module 786A, which is configured to perform the features described above in reference to FIGS. 1A-3.

In some embodiments, software components stored in the memory 778 include a task and processing management module 783 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, the task and processing management module 783 uses data 788 (e.g., device data 790) to distribute the one or more front-end and/or back-end tasks based on communicatively coupled devices' computing resources, available power, thermal headroom, ongoing operations, and/or other factors. For example, the task and processing management module 783 can cause the performance of one or more back-end tasks (of an operation performed at communicatively coupled AR device 600) at the HIPD 700 in accordance with a determination that the operation is utilizing a predetermined amount (e.g., at least 70%) of computing resources available at the AR device 600.

In some embodiments, software components stored in the memory 778 include an interoperability module 784 for exchanging and utilizing information received and/or provided to distinct communicatively coupled devices. The interoperability module 784 allows for different systems, devices, and/or applications to connect and communicate in a coordinated way without user input. In some embodiments, software components stored in the memory 778 include an AR module 785 that is configured to process signals based at least on sensor data for use in an AR and/or VR environment. For example, the AR processing module 785 can be used for 3D object manipulation, gesture recognition, facial and facial expression, recognition, etc.

The memory 778 can also include data 787, including structured data. In some embodiments, the data 787 can include profile data 789, device data 789 (including device data of one or more devices communicatively coupled with the HIPD 700, such as device type, hardware, software, configurations, etc.), sensor data 791, media content data 792, application data 793, and notification data 794, which stores data related to the performance of the features described above in reference to FIGS. 1A-3.

It should be appreciated that the HIPD computing system 740 is an example of a computing system within the HIPD 700, and that the HIPD 700 can have more or fewer components than shown in the HIPD computing system 740, combine two or more components, and/or have a different configuration and/or arrangement of the components. The various components shown in HIPD computing system 740 are implemented in hardware, software, firmware, or a combination thereof, including one or more signal processing and/or application-specific integrated circuits.

The techniques described above in FIG. 7A-7B can be used with any device used as a human-machine interface controller. In some embodiments, an HIPD 700 can be used in conjunction with one or more wearable device such as a head-wearable device (e.g., AR device 600 and VR device 610) and/or a wrist-wearable device 500 (or components thereof). In some embodiments, an HIPD 700 can also be used in conjunction with a wearable garment, such as smart textile-based garment 800 (FIGS. 8A-8C). Having thus described example HIPD 700, attention will now be turned to example feedback devices, such as smart textile-based garment 800.

### Example Smart Textile-Based Garments

FIGS. 8A and 8B illustrate an example smart textile-based garment, in accordance with some embodiments. The smart textile-based garment 800 (e.g., wearable gloves, a shirt, a headband, a wristbands, socks, etc.) is configured to communicatively couple with one or more electronic devices, such as a wrist-wearable device 500, a head-wearable device, an HIPD 700, a laptop, tablet, and/or other computing devices. The smart textile-based garment 800 can perform various functions and/or operations associated with navigating through user interfaces and selectively opening applications, as well as the functions and/or operations described above with reference to FIGS. 1A-3.

The smart textile-based garment 800 can be part of an AR system, such as AR system 400d described above in reference to FIGS. 4D-1 and 4D-2. The smart textile-based garment 800 is also configured to provide feedback (e.g., tactile or other haptic feedback) to a user based on the user's interactions with a computing system (e.g., navigation of a user interface, operation of an application (e.g., game vibrations, media responsive haptics), device notifications, etc.)), and/or the user's interactions within an AR environment. In some embodiments, the smart textile-based garment 800 receives instructions from a communicatively coupled device (e.g., the wrist-wearable device 500, a head-wearable device, and HIPD 700, etc.) for causing the performance of a feedback response. Alternatively, or in addition, in some embodiments, the smart textile-based garment 800 determines one or more feedback responses to provide a user. The smart textile-based garment 800 can determine the one or more feedback responses based on sensor data captured by one or more of its sensors (e.g., sensors 851; FIG. 8C) or communicatively coupled sensors (e.g., sensors of a wrist-wearable device 500, a head-wearable device, an HIPD 700, and/or other computing device).

Non-limiting examples of the feedback determined by the smart textile-based garment 800 and/or a communicatively coupled device include visual feedback, audio feedback, haptic (e.g., tactile, kinesthetic, etc.) feedback, thermal or temperature feedback, and/or other sensory perceptible feedback. The smart textile-based garment 800 can include respective feedback devices (e.g., a haptic device or assembly 862 or other feedback devices or assemblies) to provide the feedback responses to the user. Similarly, the smart textile-based garment 800 can communicatively couple with another device (and/or the other device's feedback devices) to coordinate the feedback provided to the user. For example, a VR device 610 can present an AR environment to a user and as the user interacts with objects within the AR environment, such as a virtual cup, the smart textile-based garment 800 provides respective response to the user. In particular, the smart textile-based garment 800 can provide haptic feedback to prevent (or, at a minimum, hinder/resist movement of) one or more of the user's fingers from bending past a certain point to simulate the sensation of touching a solid cup and/or thermal feedback to simulate the sensation of a cold or warm beverage.

Additionally or alternatively, in some embodiments, the smart textile-based garment 800 is configured to operate as a controller configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 1A-3.

FIG. 8A shows one or more haptic assemblies 862 (e.g., first through fourth haptic assemblies 862-1 through 862-4) on a portion of the smart textile-based garment 800 adjacent to a palmar side of the user's hand and FIG. 8B shows additional haptic assemblies (e.g., a fifth haptic assembly 862-5) on a portion of the smart textile-based garment 800 adjacent to a dorsal side of the user's hand. In some embodiments, the haptic assemblies 862 include a mechanism that, at a minimum, provide resistance when a respective haptic assembly 862 is transitioned from a first state (e.g., a first pressurized state (e.g., at atmospheric pressure or deflated)) to a second state (e.g., a second pressurized state (e.g., inflated to a threshold pressure)). In other words, the haptic assemblies 862 described can transition between a first pressurized state and a second pressurized state to provide haptic feedback to the user. Structures of haptic assemblies 862 can be integrated into various devices configured to be in contact or proximity to a user's skin, including, but not limited to devices such as glove worn devices, body worn clothing device, headset devices. Each of the haptic assemblies 862 can be included in or physically coupled to a garment component 804 of the smart textile-based garment 800. For example, each of the haptic assemblies 862-1, 862-2, 862-3, . . . 862-N are physically coupled to the garment 804 are configured to contact respective phalanges of a user's thumb and fingers.

Due to the ever-changing nature of artificial-reality, the haptic assemblies 862 may be required to transition between the multiple states hundreds, or perhaps thousands of times, during a single use. Thus, the haptic assemblies 862 described herein are durable and designed to quickly transition from state to state. To provide some context, in a first pressurized state, the haptic assemblies 862 do not impede free movement of a portion of the wearer's body. For example, one or more haptic assemblies 862 incorporated into a glove are made from flexible materials that do not impede free movement of the wearer's hand and fingers (e.g., an electrostatic-zipping actuator). The haptic assemblies 862 are configured to conform to a shape of the portion of the wearer's body when in the first pressurized state. However, once in a second pressurized state, the haptic assemblies 862 can be configured to restrict and/or impede free movement of the portion of the wearer's body (e.g., appendages of the user's hand). For example, the respective haptic assembly 862 (or multiple respective haptic assemblies) can restrict movement of a wearer's finger (e.g., prevent the finger from curling or extending) when the haptic assembly 862 is in the second pressurized state. Moreover, once in the second pressurized state, the haptic assemblies 862 may take different shapes, with some haptic assemblies 862 configured to take a planar, rigid shape (e.g., flat and rigid), while some other haptic assemblies 862 are configured to curve or bend, at least partially.

The smart textile-based garment 800 can be one of a plurality of devices in an AR system (e.g., AR systems of FIGS. 4A-4D-2). For example, a user can wear a pair of gloves (e.g., a first type of smart textile-based garment 800), wear a haptics component of a wrist-wearable device 500 (FIGS. 5A-5B), wear a headband (e.g., a second type of smart textile-based garment 800), hold an HIPD 700, etc. As explained above, the haptic assemblies 862 are configured to provide haptic simulations to a wearer of the smart textile-based garments 800. The garment 804 of each smart textile-based garment 800 can be one of various articles of clothing (e.g., gloves, socks, shirts, pants, etc.). Thus, a user may wear multiple smart textile-based garments 800 that are each configured to provide haptic stimulations to respective parts of the body where the smart textile-based garments 800 are being worn. Although the smart textile-based garment 800 are described as an individual device, in some embodiments, the smart textile-based garment 800 can be combined with other wearable devices described herein. For example, the smart textile-based garment 800 can form part of a VR device 610 (e.g., a headband portion).

FIG. 8C shows block diagrams of a computing system 840 of the haptic assemblies 862, in accordance with some embodiments. The computing system 840 can include one or more peripheral interfaces 850, one or more power systems 895 (including charger input 896, PMIC 897, and battery 898), one or more controllers 875 (including one or more haptic controllers 876), one or more processors 877 (as defined above, including any of the examples provided), and memory 878, which can all be in electronic communication with each other. For example, the one or more processors 877 can be configured to execute instructions stored in the memory 878, which can cause a controller of the one or more controllers 875 to cause operations to be performed at one or more peripheral devices of the peripherals interface 850. In some embodiments, each operation described can occur based on electrical power provided by the power system 895.

In some embodiments, the peripherals interface 850 can include one or more devices configured to be part of the computing system 840, many of which have been defined above and/or described with respect to wrist-wearable devices shown in FIGS. 5A-7B. For example, the peripherals interface 850 can include one or more sensors 851, such as one or more pressure sensors 852, one or more EMG sensors 856, one or more IMUs 858, one or more position sensors 859, one or more capacitive sensors 860, one or more force sensors 861; and/or any other types of sensors defined above or described with respect to any other embodiments discussed herein. In some embodiments, the peripherals interface can include one or more additional peripheral devices including one or more WiFi and/or Bluetooth devices 868; an LTE component 869; a GPS component 870; a microphone 871; one or more haptic assemblies 862; one or more support structures 863 (which can include one or more bladders 864; one or more manifolds 865; one or more pressure-changing devices 867; one or more displays 872; one or more buttons 873; one or more speakers 874; and/or any other types of peripheral devices defined above or described with respect to any other embodiments discussed herein. In some embodiments, computing system 840 includes more or less components that those shown in FIG. 8C.

In some embodiments, each haptic assembly 862 includes a support structure 863, and at least one bladder 864. The bladder 864 (e.g., a membrane) is a sealed, inflatable pocket made from a durable and puncture resistance material, such as thermoplastic polyurethane (TPU), a flexible polymer, or the like. The bladder 864 contains a medium (e.g., a fluid such as air, inert gas, or even a liquid) that can be added to or removed from the bladder 864 to change a pressure (e.g., fluid pressure) inside the bladder 864. The support structure 863 is made from a material that is stronger and stiffer than the material of the bladder 864. A respective support structure 863 coupled to a respective bladder 864 is configured to reinforce the respective bladder 864 as the respective bladder changes shape and size due to changes in pressure (e.g., fluid pressure) inside the bladder. The above example haptic assembly 862 is non-limiting. The haptic assembly 862 can include eccentric rotating mass (ERM), linear resonant actuators (LRA), voice coil motor (VCM), piezo haptic actuator, thermoelectric devices, solenoid actuators, ultrasonic transducers, thermo-resistive heaters, Peltier devices, and/or other devices configured to generate a perceptible response.

The smart textile-based garment 800 also includes a haptic controller 876 and a pressure-changing device 867. Alternatively, in some embodiments, the computing system 840 is communicatively coupled with a haptic controller 876 and/or pressure-changing device 867 (e.g., in electronic communication with one or more processors 877 of the computing system 840). The haptic controller 876 is configured to control operation of the pressure-changing device 867, and in turn operation of the smart textile-based garments 800. For example, the haptic controller 876 sends one or more signals to the pressure-changing device 867 to activate the pressure-changing device 867 (e.g., turn it on and off). The one or more signals can specify a desired pressure (e.g., pounds-per-square inch) to be output by the pressure-changing device 867. Generation of the one or more signals, and in turn the pressure output by the pressure-changing device 867, can be based on information collected by sensors 851 of the smart textile-based garment 800 and/or other communicatively coupled device. For example, the haptic controller 876 can provide one or more signals, based on collected sensor data, to cause the pressure-changing device 867 to increase the pressure (e.g., fluid pressure) inside a first haptic assembly 862 at a first time, and provide one or more additional signals, based on additional sensor data, to the pressure-changing device 867 to cause the pressure-changing device 867 to further increase the pressure inside a second haptic assembly 862 at a second time after the first time. Further, the haptic controller 876 can provide one or more signals to cause the pressure-changing device 867 to inflate one or more bladders 864 in a first portion of a smart textile-based garment 800 (e.g., a first finger), while one or more bladders 864 in a second portion of the smart textile-based garment 800 (e.g., a second finger) remain unchanged. Additionally, the haptic controller 876 can provide one or more signals to cause the pressure-changing device 867 to inflate one or more bladders 864 in a first smart textile-based garment 800 to a first pressure and inflate one or more other bladders 864 in the first smart textile-based garment 800 to a second pressure different from the first pressure. Depending on the number of smart textile-based garments 800 serviced by the pressure-changing device 867, and the number of bladders therein, many different inflation configurations can be achieved through the one or more signals and the examples above are not meant to be limiting.

The smart textile-based garment 800 may include an optional manifold 865 between the pressure-changing device 867, the haptic assemblies 862, and/or other portions of the smart textile-based garment 800. The manifold 865 may include one or more valves (not shown) that pneumatically couple each of the haptic assemblies 862 with the pressure-changing device 867 via tubing. In some embodiments, the manifold 865 is in communication with the controller 875, and the controller 875 controls the one or more valves of the manifold 865 (e.g., the controller generates one or more control signals). The manifold 865 is configured to switchably couple the pressure-changing device 867 with one or more haptic assemblies 862 of the smart textile-based garment 800. In some embodiments, one or more smart textile-based garment 800 or other haptic devices can be coupled in a network of haptic device and the manifold 865 can distribute the fluid between the coupled smart textile-based garments 800.

In some embodiments, instead of using the manifold 865 to pneumatically couple the pressure-changing device 867 with the haptic assemblies 862, the smart textile-based garment 800 may include multiple pressure-changing devices 867, where each pressure-changing device 867 is pneumatically coupled directly with a single (or multiple) haptic assembly 862. In some embodiments, the pressure-changing device 867 and the optional manifold 865 can be configured as part of one or more of the smart textile-based garments 800 (not illustrated) while, in other embodiments, the pressure-changing device 867 and the optional manifold 865 can be configured as external to the smart textile-based garments 800. In some embodiments, a single pressure-changing device 867 can be shared by multiple smart textile-based garment 800 or other haptic devices. In some embodiments, the pressure-changing device 867 is a pneumatic device, hydraulic device, a pneudraulic device, or some other device capable of adding and removing a medium (e.g., fluid, liquid, gas) from the one or more haptic assemblies 862.

The memory 878 includes instructions and data, some or all of which may be stored as non-transitory computer-readable storage media within the memory 878. For example, the memory 878 can include one or more operating systems 879; one or more communication interface applications 881; one or more interoperability modules 884; one or more AR processing applications 885; one or more data management modules 886; and a notification modules 887 for providing notifications; and/or any other types of data defined above or described with respect to FIGS. 5A-7B.

The memory 878 also includes data 888 which can be used in conjunction with one or more of the applications discussed above. The data 888 can include: device data 890; sensor data 891; notification data 894; and/or any other types of data defined above or described with respect to FIGS. 5A-7B.

The different components of the computing system 840 (and the smart textile-based garment 800) shown in FIGS. 8A-8C can be coupled via a wired connection (e.g., via busing). Alternatively, one or more of the devices shown in FIGS. 8A-8C may be wirelessly connected (e.g., via short-range communication signals).

What is claimed is:

1. A system for selecting output modalities for notifications based on situational awareness, the system comprising:
a head-wearable device that is in communication with a mobile device different from the head-wearable device, wherein the system is configured to:
in response to receiving a request to output a first notification:
obtaining first sensor data from the head-wearable device and the mobile device used to determine a physical-environment characteristic for an environment in which a user of the head-wearable device is located;
based on the physical-environment characteristic, determining a first output modality at the head-wearable device or the mobile device for presenting the first notification to the user;
in response to receiving a request to output a second notification that is a of a distinct type from the first notification:
obtaining second sensor data from the head-wearable device and the mobile device used to determine a new physical-environment characteristic for an environment in which a user of the head-wearable device is located;
based on the new physical-environment characteristic, determining a new output modality, distinct from the first output modality, at the head-wearable device or the mobile device for presenting the second notification to the user.

2. The system of claim 1, wherein the first sensor data includes data from a microphone of the system.

3. The system of claim 2, wherein the first sensor data includes information from the microphone indicating a conversation is occurring with the user, and presenting the first notification includes delaying presentation of the first notification until after the conversation has been determined to be concluded.

4. The system of claim 2, wherein the first sensor data includes information indicating a conversation is occurring with the user, and the first output modality is a non-audio-based output modality.

5. The system of claim 2, wherein the first sensor data includes information from the microphone indicating the system is in a loud environment, and the first output modality is a non-audio-based output modality.

6. The system of claim 1, wherein the first sensor data includes data that is retrieved from a camera of the system.

7. The system of claim 1, wherein the first sensor data includes data that is retrieved from a global position system (GPS) of the system.

8. The system of claim 1, wherein the first sensor data from the one or more sensors is retrieved from an inertial measurement sensor of the system.

9. The system of claim 1, wherein the first output modality includes presenting the first notification via multiple output modalities of the system.

10. The system of claim 1, wherein presenting the first notification to the user includes providing a haptic feedback provided by a haptic feedback generator of the head-wearable device or the mobile device.

11. The system of claim 1, wherein the first output modality includes presenting the first notification using a display of the head-wearable device.

12. The system of claim 1, wherein the system is further configured to:
in response to receiving the request to output a third notification different from the first notification and the second notification:
in accordance with a determination that the third notification is a high priority notification, providing the third notification irrespective of another determined physical-environment characteristic of an environment.

13. The system of claim 1, wherein the mobile device is a wrist-wearable device, and the first output modality is one or more of a haptic feedback, an auditory feedback, and a visual feedback.

14. The system of claim 1, wherein the first notification is provided at time later than when the request to provide the notification was received.

15. A non-transitory computer-readable storage medium storing one or more programs, the one or more programs comprising instructions that when executed by a system that includes a head-wearable device that is in communication with a mobile device, causes the system to perform or cause performance of:
in response to receiving a request to output a first notification:
obtaining first sensor data from the head-wearable device and the mobile device used to determine a physical-environment characteristic for an environment in which a user of the head-wearable device is located;
based on the physical-environment characteristic, determining a first output modality at the head-wearable device or the mobile device for presenting the first notification to the user;
in response to receiving a request to output a second notification that is a of a distinct type from the first notification:
obtaining second sensor data from the head-wearable device and the mobile device used to determine a new physical-environment characteristic for an environment in which a user of the head-wearable device is located;
based on the new physical-environment characteristic, determining a new output modality, distinct from the first output modality, at the head-wearable device or the mobile device for presenting the second notification to the user.

16. The non-transitory computer-readable storage medium of claim 15, wherein the first sensor data includes data from a microphone of the system.

17. The non-transitory computer-readable storage medium of claim 16, wherein the first sensor data includes information from the microphone indicating a conversation is occurring with the user, and presenting the first notification includes delaying presentation of the notification until after the conversation has been determined to be concluded.

18. A method for selecting output modalities for notifications based on situational awareness, the method comprising:
at a head-wearable device that is in communication with a mobile device different from the head-wearable device:
in response to receiving a request to output a first notification:
obtaining first sensor data from the head-wearable device and the mobile device used to determine a physical-environment characteristic for an environment in which a user of the head-wearable device is located;
based on the physical-environment characteristic, determining a first output modality at the head-wearable device or the mobile device for presenting the first notification to the user;
in response to receiving a request to output a second notification that is a of a distinct type from the first notification:
obtaining second sensor data from the head-wearable device and the mobile device used to determine a new physical-environment characteristic for an environment in which a user of the head-wearable device is located;
based on the new physical-environment characteristic, determining a new output modality, distinct from the first output modality, at the head-wearable device or the mobile device for presenting the second notification to the user.

19. The method of claim 18, wherein the first sensor data includes data from a microphone of either the head-wearable device or the mobile device.

20. The method of claim 19, wherein the first sensor data includes information from the microphone indicating a conversation is occurring with the user, and presenting the first notification includes delaying presentation of the notification until after the conversation has been determined to be concluded.
